(19) United States
(12) Patent Application Publication
(10) Pub. No.: US 2026/0181089 A1
(43) Pub. Date: Jun. 25, 2026

(54) IMAGE READING APPARATUS, DOCUMENT DETECTION METHOD, AND DOCUMENT READING METHOD

(71) Applicant: SEIKO EPSON CORPORATION, TOKYO (JP)

(72) Inventor: Kento YOKOUCHI, KITAKYUSHU-SHI (JP)

(21) Appl. No.: 19/426,666

(22) Filed: Dec. 19, 2025

(30) Foreign Application Priority Data
Dec. 19, 2024 (JP) 2024-224222

(51) Int. Cl. H04N 1/00

(52) U.S. Cl. CPC H04N 1/00798; H04N 1/00551; H04N 1/00702

(57) ABSTRACT

A control unit provided in an image reading apparatus executes first reading processing of, when a document cover is in an open state and before a document is placed on a placement surface, causing a reading unit to carry out reading in a state in which a light emitting unit is turned off. The control unit executes second reading processing of causing the reading unit to carry out reading in a state in which the document cover is in the open state and the light emitting unit is turned off. The control unit detects, based on a difference between a first reading result obtained by the first reading processing and a second reading result obtained by the second reading processing, that the document has been placed on the placement surface.

The present application is based on, and claims priority from JP Application Serial Number 2024-224222, filed Dec. 19, 2024, the disclosure of which is hereby incorporated by reference herein in its entirety.

### BACKGROUND

### 1. Technical Field

The present disclosure relates to an image reading apparatus including a reading unit that reads a document, a document detection method, and a document reading method.

### 2. Related Art

For example, JP-A-2013-85047 discloses a method of detecting a size of a document with a line sensor (an example of a reading unit) that reads the document in an image reading apparatus. When an opening and closing detection unit (an example of an opening and closing sensor) detects that a document pressing unit (an example of a document cover) has been tilted below a predetermined position, reading by the line sensor is performed in a state in which the document is irradiated with light by a lamp (an example of a light emitting unit).

In the technique disclosed in JP-A-2013-85047, image data for disturbance light detection is generated by causing the line sensor to perform reading under an open state in which a document pressing unit is lifted above the predetermined position and a turn-off state of the lamp. Image data for document size detection is generated by causing the line sensor to perform reading under a closed state in which the document pressing portion is tilted below the predetermined position and a turn-on state of the lamp. The document size is detected based on the image data for disturbance light detection and the image data for document size detection. For this reason, in the technique of JP-A-2013-85047, it is possible to detect the document size without being affected by disturbance light.

JP-A-2013-85047 is an example of the related art.

However, when the document cover is in the open state, it is sometimes desired to detect that the document has been placed on a placement surface of a document table. It is presumed that the technique of JP-A-2013-85047 can detect the presence or absence of the document because the document size can be detected. In this technique, it is necessary to perform reading in the turned-off state of the light emitting unit under the open state of the document cover and reading in the turn-on state of the light emitting unit under the closed state of the document cover. For this reason, in order to detect the presence or absence of the document, operation for closing the document cover is necessary and power consumption increases according to the turn-on of the light emitting unit. Thus, there is a demand for implementing, even when the document cover remains in the open state, with low power consumption, document detection for detecting that the document is placed on the placement surface of the document table.

### SUMMARY

According to an aspect of the present disclosure, there is provided an image reading apparatus including: a document table having a placement surface on which a document is placed; a reading unit configured to read, on a side opposite to the placement surface, the document placed on the placement surface of the document table; a light emitting unit capable of switching turn-on and turn-off and configured to illuminate the document from the side opposite to the placement surface of the document table in a turn-on state; a document cover configured to open and close the placement surface of the document table; and a control unit, wherein, based on detecting placement of the document on the placement surface based on a difference between a first reading result obtained by first reading processing of, when the document cover is in an open state and before the document is placed on the placement surface, causing the reading unit to carry out reading in a state in which the light emitting unit is turned off and a second reading result obtained by second reading processing of causing the reading unit to carry out reading in a state in which the document cover is in an open state and the light emitting unit is turned off, the control unit executes document reading processing of causing the reading unit to read the document.

According to an aspect of the present disclosure, there is provided a document detection method of detecting a document placed on a document table in an image reading apparatus including: the document table having a placement surface on which the document is placed; a reading unit configured to read, on a side opposite to the placement surface, the document placed on the placement surface of the document table; a light emitting unit capable of switching turn-on and turn-off and configured to illuminate the document from the side opposite to the placement surface of the document table in a turn-on state; and a document cover configured to open and close the placement surface of the document table, the document detection method including: when it is determined, based on a result of executing first reading processing of, when the document cover is in an open state and before the document is placed on the placement surface, causing the reading unit to carry out reading in a state in which the light emitting unit is turned off, that the document placed on the placement surface can be detected, executing second reading processing of causing the reading unit to carry out reading in a state in which the document cover is in the open state and the light emitting unit is turned off; and detecting the document placed on the placement surface based on a difference between a result of the second reading processing and a result by the first reading processing.

According to an aspect of the present disclosure, there is provided a document reading method of reading a document placed on a document table in an image reading apparatus including: the document table having a placement surface on which the document is placed; a reading unit configured to read, on a side opposite to the placement surface, the document placed on the placement surface of the document table; a light emitting unit capable of switching turn-on and turn-off and configured to illuminate the document from the side opposite to the placement surface of the document table in a turn-on state; and a document cover configured to open and close the placement surface of the document table, the document detection method including: when it is determined, based on a result of executing first reading processing of, when the document cover is in an open state and before the document is placed on the placement surface, causing the reading unit to carry out reading in a state in which the light emitting unit is turned off, that the document placed on the placement surface can be detected, executing second reading processing of causing the reading unit to carry out reading in a state in which the document cover is in the open state and the light emitting unit is turned off; and detecting the document placed on the placement surface based on a difference between a result of the second reading processing and a result by the first reading processing.

### BRIEF DESCRIPTION OF THE DRAWINGS

FIG. 1 is a schematic front cross-sectional view illustrating an image reading apparatus according to an embodiment.

FIG. 2 is a schematic plan view illustrating the image reading apparatus.

FIG. 3 is a partially cutaway schematic front view of the image reading apparatus on which a document is placed.

FIG. 4 is a schematic plan view illustrating a configuration of a reading module.

FIG. 5 is a block diagram illustrating an electric configuration of the image reading apparatus.

FIG. 6 is a schematic diagram illustrating the image reading apparatus at the time when a document cover is in an open state and the document is in a state of before being placed and a graph illustrating read data at that time.

FIG. 7 is a schematic diagram illustrating the image reading apparatus at the time when the document is placed under the open state of the document cover and a graph illustrating read data at that time.

FIG. 8 is a graph illustrating a difference between a first reading result and a second reading result.

FIG. 9 is a graph illustrating differential data.

FIG. 10 is a flowchart illustrating a document reading control routine including document placement detection processing.

### DESCRIPTION OF EMBODIMENTS

Hereinafter, an embodiment of an image reading apparatus will be described with reference to the drawings.

### Image Reading Apparatus

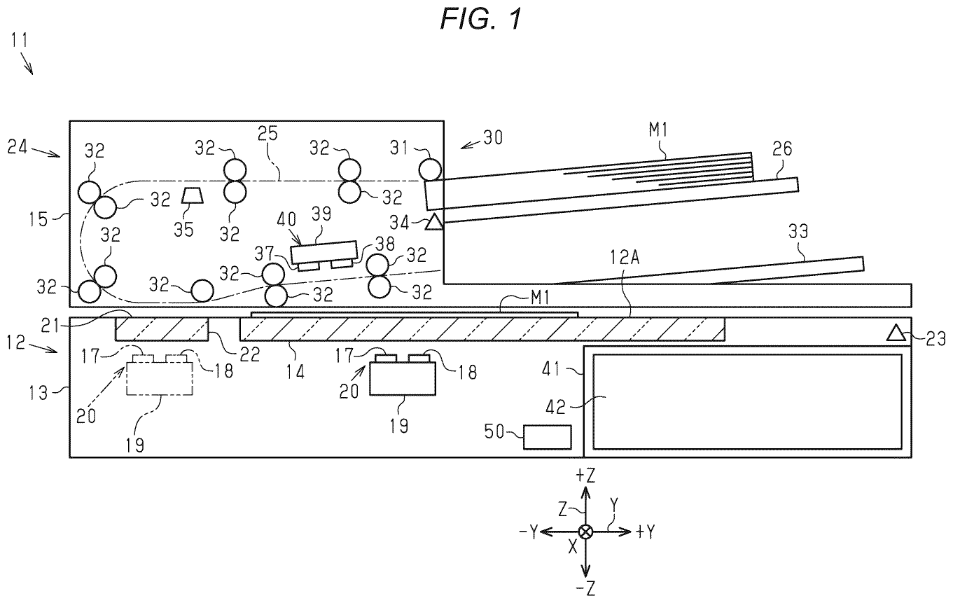

FIG. 1 illustrates an image reading apparatus 11 that is in a posture in a use state. XYZ axes illustrated in FIG. 1 are orthogonal to one another. The Z axis is an axis parallel to the direction of gravity. The Y axis is an axis parallel to the width direction of the image reading apparatus 11 when viewed from the front illustrated in FIG. 1. The X axis is an axis parallel to the depth direction of the image reading apparatus 11. Directions parallel to the X axis, the Y axis, and the Z axis are respectively represented as an X direction, a Y direction, and a Z direction. The X direction includes both of a +X direction and a −X direction. The Y direction includes both of a +Y direction and a −Y direction. The Z direction includes both of a +Z direction and a −Z direction. The Y direction is also referred to as width direction Y, the X direction is also referred to as depth direction X, and the Z direction is also referred to as vertical direction Z.

As illustrated in FIG. 1, the image reading apparatus 11 includes a document table 12 and a document cover 15. The document table 12 has a placement surface 12A on which a document M1 is placed. The document M1 is set on the document table 12 by being placed on the placement surface 12A.

The document table 12 includes a housing 13 and a transparent plate 14. The transparent plate 14 is attached to an upper part of the housing 13. The transparent plate 14 configures a top plate of the housing 13. The upper surface of the transparent plate 14 configures the placement surface 12A. That is, the upper surface of a portion where the transparent plate 14 is exposed on the upper surface of the document table 12 is the placement surface 12A. The placement surface 12A has a size for enabling a document M1 having a largest size readable by the image reading apparatus 11 to be placed.

The document cover 15 is configured to be capable of turning with respect to the document table 12. The document cover 15 opens and closes the placement surface 12A of the document table 12. The document cover 15 is attached to the document table 12 via a turning mechanism (not illustrated). In the front view illustrated in FIG. 1, a turning axis of the document cover 15 is located on the +X side in the depth direction X and extends in the width direction Y. The document cover 15 can be opened and closed within a range of a predetermined angle centering on the turning axis on the back side.

When the document cover 15 is opened, the placement surface 12A, which is the upper surface of the transparent plate 14, is exposed. Accordingly, a user can place (set) the document M1 on the placement surface 12A. The document cover 15 presses the document M1 placed on the placement surface 12A from above by being closed with respect to the document table 12. In the state illustrated in FIG. 1, the document M1 placed on the placement surface 12A is pressed against the placement surface 12A by the document cover 15 in the closed state. In this state, the document M1 is read by the image reading apparatus 11.

The image reading apparatus 11 includes a reading unit 17 and a light emitting unit 18. The image reading apparatus 11 may include a carriage 19 that supports the reading unit 17 and the light emitting unit 18.

The reading unit 17 is configured to read the document M1 placed on the placement surface 12A. The reading unit 17 reads, on the side opposite to the placement surface 12A, the document M1 placed on the placement surface 12A of the document table 12. The reading unit 17 is located in the housing 13 of the document table 12. The reading unit 17 is located on the side opposite to the placement surface 12A across the transparent plate 14. The reading unit 17 is configured to scan the inside of the housing 13.

As illustrated in FIG. 1, the carriage 19 that supports the reading unit 17 is configured to be movable in the width direction Y. The reading unit 17 is configured to move in the width direction Y together with the carriage 19 in a state of facing the placement surface 12A on the transparent plate 14 and along the placement surface 12A. The reading unit 17 scans the document M1 placed on the placement surface 12A to thereby read the document M1 through the transparent plate 14. The reading unit 17 is movable over a range wider than the placement surface 12A in the width direction Y.

The reading unit 17 includes, for example, a line sensor assuming a shape long in one direction. In the example illustrated in FIG. 1, the reading unit 17 is disposed in a direction in which the longitudinal direction thereof is parallel to the depth direction X. The longitudinal direction of the reading unit 17 including the line sensor is referred to as main scanning direction and a moving direction of the reading unit 17 is referred to as sub scanning direction. Since the main scanning direction is a direction parallel to the depth direction X, the main scanning direction is also referred to as “main scanning direction X”. Since the sub scanning direction is a direction parallel to the width direction Y, the sub scanning direction is also referred to as “sub scanning direction Y”. The reading unit 17 is movable in the +Y direction and the −Y direction of the sub scanning direction Y according to the movement of the carriage 19. The main scanning direction X and the sub scanning direction Y intersect (for example, are orthogonal to) each other.

The carriage 19 moves the reading unit 17 along the document table 12. The carriage 19 moves the reading unit 17 in the sub scanning direction Y. The carriage 19 is capable of reading a region including the entire surface of the document M1 placed on the placement surface 12A by moving, in the sub scanning direction Y, the reading unit 17 including the line sensor extending in the main scanning direction X.

The light emitting unit 18 is capable of switching turn-on and turn-off. The light emitting unit 18 is located in the housing 13 of the document table 12. The light emitting unit 18 illuminates the document M1 from the side opposite to the placement surface 12A of the document table 12 in a turn-on state. The light emitting unit 18 illuminates, from the side opposite to the placement surface 12A, a portion to be read by the reading unit 17 in the document M1.

The light emitting unit 18 is configured to scan the inside of the housing 13. The light emitting unit 18 illuminates, through the transparent plate 14, the document M1 placed on the placement surface 12A of the document table 12. The light emitting unit 18 is supported by an upper part of the carriage 19 to move along the placement surface 12A of the document table 12 together with the reading unit 17. The light emitting unit 18 moves in the sub scanning direction Y when the carriage 19 moves. The light emitting unit 18 is supported by the carriage 19 at a position satisfying a positional relationship in which a region including a portion to be read by the reading unit 17 in a surface to be read of the document M1 placed on the placement surface 12A can be illuminated. The light emitting unit 18 is lit to illuminate a reading target region extending along the main scanning direction X of the reading unit 17 including the line sensor.

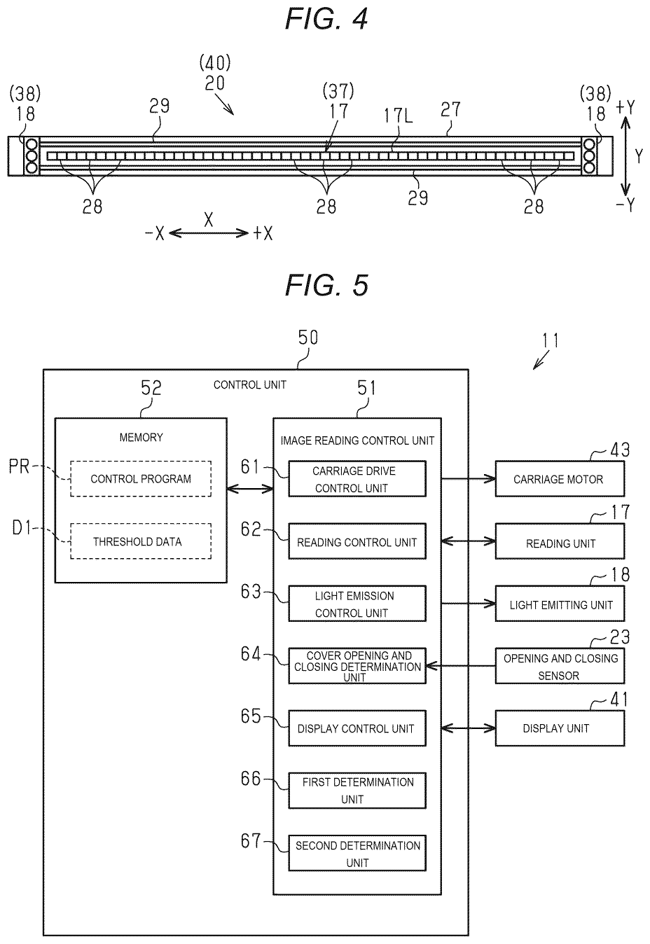

The reading unit 17 and the light emitting unit 18 configure a reading module 20 (see FIG. 4 as well). The reading module 20 is supported by the upper part of the carriage 19. In the reading module 20 in the present embodiment, the reading unit 17 is, for example, a contact image sensor module (CISM) of a contact image sensor (CIS) scheme (a close contact optical scheme). A detailed configuration of the reading module 20 is explained below.

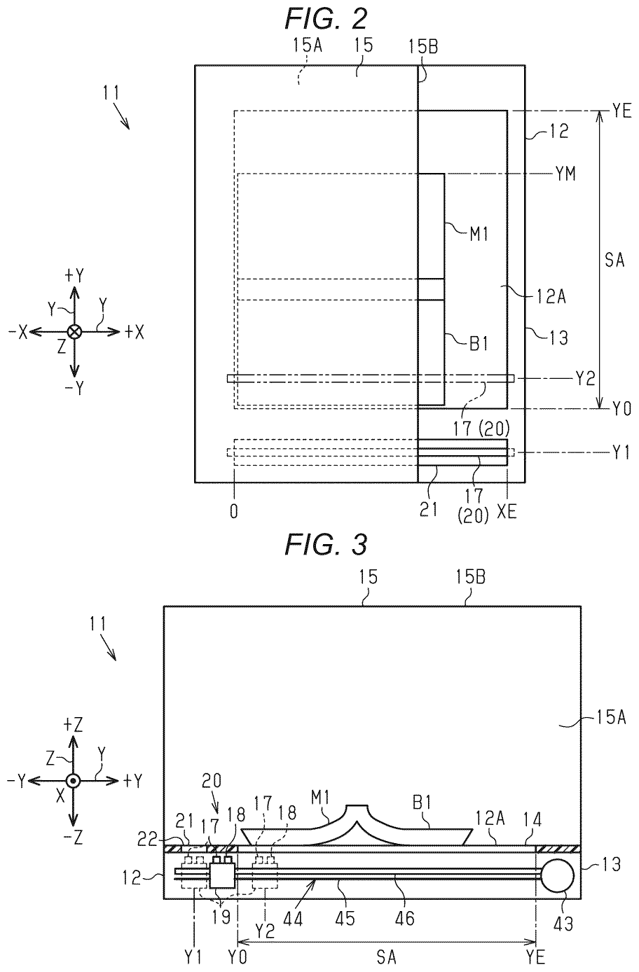

The image reading apparatus 11 may include a reading window section 21. The reading window section 21 may be located on the outer side of the placement surface 12A in plan view (see FIG. 2 as well). In the example illustrated in FIG. 1, the reading window section 21 is located on the outer side in the sub scanning direction Y with respect to the placement surface 12A. The reading window section 21 may be provided at a position that the reading unit 17 can face. The reading window section 21 is disposed at a position adjacent to the transparent plate 14 in the sub scanning direction Y in an upper part of the document table 12. The reading window section 21 and the transparent plate 14 are respectively attached to positions that are both in a parallel state to and at substantially the same height as the upper part of the housing 13.

The reading unit 17 is configured to be movable to, according to the movement of the carriage 19, a position indicated by an alternate long and two short dashes line in FIG. 1, the position facing the reading window section 21. The carriage 19 is movable in the sub scanning direction Y over a movement range including a position where the reading unit 17 faces the reading window section 21 and a region where the reading unit 17 faces the placement surface 12A. Accordingly, the reading unit 17 is capable of moving (scanning), according to the movement of the carriage 19, in the sub scanning direction Y over a scanning range including the position facing the reading window section 21 and a region facing the transparent plate 14.

The reading window section 21 includes a small-sized transparent plate 22 that is sufficiently smaller compared with the size of the transparent plate 14. The transparent plates 14 and 22 are made of, for example, glass. The transparent plate 14 is made of large glass larger than the size of the transparent plate 22 made of small glass forming the reading window section 21. The transparent plate 22 is made of small glass smaller than the large glass. The positions and lengths in the main scanning direction X of the transparent plate 14 and the reading window section 21 are substantially the same.

The image reading apparatus 11 may include an opening and closing sensor 23. The opening and closing sensor 23 detects opening and closing of the document cover 15. The opening and closing sensor 23 is configured to be capable of detecting an open state and a closed state of the document cover 15. The opening and closing sensor 23 may detect that the document cover 15 is open with respect to the document table 12 or may detect that the document cover 15 is closed with respect to the document table 12. The opening and closing sensor 23 is attached to, for example, the housing 13 but may be attached to the document cover 15. The opening and closing sensor 23 may be a contact sensor or a non-contact sensor such as an optical sensor. For example, in the depth direction X of the image reading apparatus 11, the opening and closing sensor 23 may be provided at a position on the back side close to the turning axis of the document cover 15 or may be provided at a position on the turning end side of the document cover 15.

The opening and closing sensor 23 may detect an open state at the time when an opening angle, which is an angle formed by the document cover 15 with respect to the placement surface 12A, is equal to or larger than a predetermined angle and a closed state at the time when the opening angle is smaller than the predetermined angle. The predetermined angle is a predetermined value within a range from 0 degree, which is an angle at the time when the document cover 15 is completely closed with respect to the document table 12, to a largest opening angle. The predetermined angle can be set to an appropriate value and, as an example, may be a predetermined value within a range of 1 degree or more and 45 degrees or less. In the present embodiment, the predetermined angle may be, for example, a predetermined value within a range of 5 degrees or more and 30 degrees or less.

The image reading apparatus 11 includes a display unit 41. The display unit 41 is configured to display a screen. The display unit 41 is, for example, a liquid crystal display. The display unit 41 is attached to, for example, the document table 12. The display unit 41 notifies information concerning the image reading apparatus 11 to the user by displaying information on the screen.

The image reading apparatus 11 includes an operation unit 42. The operation unit 42 is operated by the user. The user operates the image reading apparatus 11 through the operation unit 42. The operation unit 42 is, for example, a touch panel. That is, the operation unit 42 may include a touch operation function unit provided in the display unit 41 that is the touch panel. The operation unit 42 may include at least one operation button displayed on the screen of the display unit 41 in order to operate the image reading apparatus 11. The user gives an instruction to the image reading apparatus 11 by performing touch operation on the screen displayed on the display unit 41. The operation unit 42 is not limited to the touch panel and may include a button, a lever, or a switch.

The image reading apparatus 11 includes a control unit 50. The control unit 50 is configured to control the image reading apparatus 11. The control unit 50 controls the reading unit 17 and the light emitting unit 18. The control unit 50 controls the movement of the carriage 19 along the placement surface 12A. The control unit 50 controls the display unit 41. The control unit 50 causes the display unit 41 to display various information. The control unit 50 controls the image reading apparatus 11 based on an instruction given to the image reading apparatus 11 by the user through operation of the operation unit 42.

The image reading apparatus 11 includes an image reading function of a flatbed scheme (FB scheme) described above and an image reading function of an auto document feeder scheme (ADF scheme) described below. Hereinafter, a configuration of the image reading function of the ADF scheme is explained with reference to FIG. 1.

### Configuration of the Image Reading Apparatus of the ADF Scheme

The image reading apparatus 11 illustrated in FIG. 1 includes an auto document feeder 24. The auto document feeder 24 is configured to automatically feed the document M1. The auto document feeder 24 is attached to the document cover 15. The auto document feeder 24 feeds the document M1 into the document cover 15. A conveyance path 25 is formed in the document cover 15. The conveyance path 25 is a path on which the document M1 is conveyed. The conveyance path 25 extends in the document cover 15. The document M1 is read by the image reading apparatus 11 in a process of being conveyed on the conveyance path 25.

The auto document feeder 24 includes a supply tray 26. The supply tray 26 is attached to the document cover 15. The supply tray 26 extends from the document cover 15. The supply tray 26 is configured such that the document M1 is set thereon. The document M1 is placed on the supply tray 26, whereby the document M1 is set on the supply tray 26.

The auto document feeder 24 includes a conveyance unit 30. The conveyance unit 30 is attached to the document cover 15. The conveyance unit 30 is configured to convey the document M1. The conveyance unit 30 conveys, along the conveyance path 25, the document M1 set on the supply tray 26. The conveyance unit 30 includes one or more rollers. The conveyance unit 30 includes, for example, a pickup roller 31 and one or more conveyance rollers 32. The pickup roller 31 conveys a plurality of documents M1 set on the supply tray 26 one by one. In an example, the pickup roller 31 comes into contact with the document M1 located at the top among the plurality of documents M1 stacked on the supply tray 26 and conveys the documents M1 in order from the document M1 located at the top. The plurality of conveyance rollers 32 are located along the conveyance path 25. The plurality of conveyance rollers 32 convey the document M1 along the conveyance path 25.

The auto document feeder 24 includes a discharge tray 33. The discharge tray 33 is configured to receive the document M1 discharged from the document cover 15. The discharge tray 33 is attached to the document cover 15. The discharge tray 33 receives the read document M1.

The auto document feeder 24 includes a detection unit 34 that detects the presence or absence of the document M1 set on the supply tray 26. The detection unit 34 may be a contact sensor or a non-contact sensor such as an optical sensor.

The auto document feeder 24 may include a double-feeding detection unit 35 that detects double-feeding of the document M1. The double-feeding detection unit 35 detects whether a plurality of documents M1 are conveyed from the supply tray 26 while overlapping. The double-feeding detection unit 35 may include an ultrasonic sensor. The double-feeding detection unit 35 detects double-feeding, for example, when an attenuation rate of ultrasound transmitted through the document M1 exceeds a threshold.

The image reading apparatus 11 includes a reading unit 37 and a light emitting unit 38. The reading unit 37 and the light emitting unit 38 are supported by a support unit 39. The reading unit 37 and the light emitting unit 38 configure a reading module 40. The support unit 39 supports the reading module 40 in a posture capable of reading the document M1 conveyed along the conveyance path 25. A configuration of the reading module 40 is basically the same as the configuration of the reading module 20 in the document table 12. The conveyance unit 30, the reading unit 37, and the light emitting unit 38, which configure the image reading mechanism of the ADF scheme, are controlled by the control unit 50.

The reading unit 37 is disposed at a position along the conveyance path 25 in the document cover 15. The reading unit 37 reads the document M1 conveyed from the supply tray 26. That is, the reading unit 37 reads the document M1 conveyed along the conveyance path 25.

The light emitting unit 38 is capable of switching turn-on and turn-off. The light emitting unit 38 is disposed at a position along the conveyance path 25. In a turn-on state, the light emitting unit 38 illuminates a region including a portion to be read by the reading unit 37 in the document M1 conveyed along the conveyance path 25.

The reading unit 17 and the reading unit 37 are configured to be capable of reading the front surface and the rear surface of the document M1 conveyed along the conveyance path 25. The reading unit 17 located in the document table 12 has both of the image reading functions of the FB scheme and the ADF scheme. In the present specification, the reading unit 17 in the document table 12 is also referred to as “first reading unit 17” and the reading unit 37 in the auto document feeder 24 is also referred to as “second reading unit 37”.

The first reading unit 17 reads, through the reading window section 21, a first surface of the document M1 conveyed along the conveyance path 25. At this time, the first reading unit 17 does not scan the document M1. The first reading unit 17 reads the first surface of the document M1 through the reading window section 21 in a state of being located at a window position facing the reading window section 21. The first surface of the document M1 is, for example, the front surface.

The second reading unit 37 reads a second surface of the document M1 conveyed along the conveyance path 25. The second surface of the document M1 is a surface on the side opposite to the first surface. The second surface of the document M1 is, for example, the rear surface.

When one side of the document M1 conveyed along the conveyance path 25 is read, the one side of the document M1 is read by the first reading unit 17. When both sides of the document M1 conveyed along the conveyance path 25 are read, both the sides of the document M1 are read by the first reading unit 17 and the second reading unit 37. That is, the first reading unit 17 reads a first surface (for example, the front surface) of the document M1 through the reading window section 21 and the second reading unit 37 reads the second surface (for example, the rear surface) of the document M1.

### Document Placement Detection Device

A thick document M1 such as a book or a booklet (hereinafter, also referred to as “book or the like”) is sometimes read by the image reading apparatus 11. For example, in a state in which a page desired to be read of a book B1 (see FIGS. 2 and 3) is opened, the user presses the opened page against the placement surface 12A. Since the book B1 is thick, the document cover 15 cannot be closed. When the user presses the document cover 15 to a closing side to press the opened page of the book B1 against the transparent plate 14, a force in an oblique direction is applied from the document cover 15 to the book B1. As a result, a placement position of the book B1 with respect to the placement surface 12A easily deviates. For that reason, the page of the book B1 is read in a state in which the document cover 15 is half opened. The user performs reading operation while pressing the book B1 with a hand.

In the image reading apparatus 11 in the present embodiment, the control unit 50 detects, using the reading unit 17, that the document M1 such as the book has been placed on the placement surface 12A. That is, the control unit 50 detects the presence or absence of the document M1 such as the book on the placement surface 12A using the reading unit 17.

For example, in the technique disclosed in JP-A-2013-85047, the presence or absence of a document is detected based on results of two times of reading operation in a state in which the light emitting unit is turned off in the open state before the document cover is tilted and a state in which the light emitting unit is turned on in the closed state halfway in tilting the document cover. However, in this document detection technique of the related art, operation of tilting and closing the document cover is necessary and power consumption increases because of turn-on of the light emitting unit. In contrast, the image reading apparatus 11 in the present embodiment includes a document placement detection device that detects that the user has placed the document M1 on the placement surface 12A under the open state of the document cover 15. The document placement detection device detects the presence or absence of the document M1 on the placement surface 12A using the reading unit 17 while suppressing an increase in power consumption involved in the turn-on of the light emitting unit 18 under the open state of the document cover 15. Details of the document placement detection device are explained below.

### Configuration of the Image Reading Apparatus 11 of the Flat Bed Scheme

A configuration of the image reading apparatus 11 is explained with reference to FIGS. 2 and 3. In FIGS. 2 and 3, a part of a configuration of the sheet feed scheme including the auto document feeder 24 is omitted. In FIGS. 2 and 3, the document M1 is a thick document such as a book or a booklet. FIGS. 2 and 3 illustrate a state in which the book B1 in an opened state of a page to be read is placed on the placement surface 12A. That is, a state in which the user sets the book B1 on the document table 12 in order to read the page of the book B1 is illustrated.

As illustrated in FIG. 2, the document table 12 assumes, for example, a rectangular shape as a shape in plan view viewed from above. A lower surface 15A of the document cover 15 assumes a rectangular shape having substantially the same size as the upper surface of the document table 12. The upper surface of the document table 12 and the lower surface 15A of the document cover 15 have substantially the same shape and size. In the closed state of the document cover 15 illustrated in FIG. 1, the document table 12 and the document cover 15 overlap in the vertical direction Z. That is, in the closed state of the document cover 15, the document cover 15 covers the entire upper surface including the placement surface 12A of the document table 12 and the reading window section 21.

As illustrated in FIGS. 2 and 3, for example, when the document M1 such as the book B1 is placed on the placement surface 12A of the document table 12, the document cover 15 is switched to an open state at a predetermined angle. The document M1 is set on the placement surface 12A of the transparent plate 14, for example, in a state of being close to two sides in the back side and on the left. In the plan view illustrated in FIG. 2, the document M1 such as the book B1 set on the placement surface 12A is in a state of slightly protruding to the near side (the +X side) of the user from the document cover 15 in the open state. In particular, work of the user setting the document M1 such as the book B1 on the placement surface 12A is performed in a state in which the document cover 15 is opened at a relatively large opening degree. For that reason, when the user sets the document M1 such as the book B1 having a normal size on the placement surface 12A, in many cases, a part of the document M1 slightly protrudes to the +X side from the document cover 15 in the open state in plan view.

As illustrated in FIG. 3, the image reading apparatus 11 includes, in the housing 13 of the document table 12, a scanning mechanism 44 that causes the carriage 19 to perform scanning in the sub scanning direction Y and a carriage motor 43 that is a drive source of the carriage 19. The carriage 19 moves in the sub scanning direction Y via the scanning mechanism 44 with a driving force of the carriage motor 43.

The scanning mechanism 44 includes a guide member 45 and a power transmission mechanism 46. The guide member 45 guides the carriage 19 to be movable in the sub scanning direction Y. The power transmission mechanism 46 transmits the driving force of the carriage motor 43 to the carriage 19 as power for the carriage 19 to move in the sub scanning direction Y. When the carriage motor 43 is driven to rotate forward, the carriage 19 moves in a first direction +Y and, when the carriage motor 43 is driven to rotate backward, the carriage 19 moves in a second direction −Y, which is a direction opposite to the first direction. Along with the movement of the carriage 19, the reading unit 17 and the light emitting unit 18 configuring the reading module 20 move in the sub scanning direction Y.

The position of the reading unit 17 indicated by a solid line in FIG. 3 is a standby position. The standby position is a position where the reading unit 17 faces a light blocking portion between the reading window section 21 and the transparent plate 14. When not performing reading, the reading unit 17 stays on standby at the standby position.

When performing reading in the sheet-feed (SF) scheme, the reading unit 17 moves to a first reading position Y1 located at one end portion in the sub scanning direction Y. The first reading position Y1 is a position where the reading unit 17 faces the reading window section 21 in the sub scanning direction Y. This position is also referred to as “window position Y1” in the present embodiment.

When performing reading in the flatbed (FB) scheme, the reading unit 17 moves to a position in a document reading region SA in the sub scanning direction Y. The document reading region SA is a region corresponding to the placement surface 12A. The document reading region SA is a region in a range from a base end Y0 to a terminal end YE of the placement surface 12A in the sub scanning direction Y. An end portion YM in the sub scanning direction Y of the document M1 such as the book B1 is located at the same position as the terminal end YE of the placement surface 12A or further on the −Y side than the terminal end YE. The reading unit 17 reads the document M1 such as the book B1 placed on the placement surface 12A by scanning the inside of the document reading region SA in the sub scanning direction Y from the standby position illustrated in FIG. 3. The reading unit 17 reads the document M1 by receiving reflected light of light emitted from the light emitting unit 18 and reflected on a surface to be read of the document M1.

In the present embodiment, when document placement detection is performed, the reading unit 17 performs reading at two positions of the window position Y1 and a second reading position Y2, which is a position in the document reading region SA. The second reading position Y2 only has to be a position where the document M1 such as the book B1 having a general size is highly likely to be placed in the document reading region SA. Examples of a position where the document M1 such as the book B1 having the general size can be placed include a position within 200 mm from the base end Y0. In the document placement detection processing, the second reading position Y2 may be, for example, a position within 100 mm from the base end Y0 in order to reduce a movement time in which the reading unit 17 moves from the first reading position Y1 (the window position Y1) to the second reading position Y2.

### Configuration of the Reading Unit 20

Next, a configuration of the reading module 20 is explained with reference to FIG. 4. The two reading modules 20 and 40 have the same basic configuration. For that reason, the configuration of the reading module 20 is explained below.

The reading module 20 includes a long support unit 27 extending in the main scanning direction X. The reading module 20 includes the reading unit 17 and the light emitting unit 18. The reading unit 17 and the light emitting unit 18 are supported by the support unit 27 in a state in which the longitudinal direction of the reading unit 17 and the light emitting unit 18 is arranged in a direction coinciding with the main scanning direction X.

As illustrated in FIG. 4, the reading unit 17 includes, for example, a line sensor 17L. The reading unit 17 including the line sensor 17L includes a plurality of image sensors 28 arrayed in a row in the main scanning direction X. The image sensor 28 is a photoelectric conversion element. The image sensor 28 is equivalent to one reading pixel (one pixel) configuring the line sensor 17L. The reading unit 17 is configured by m image sensors 28 being arrayed in a row in the main scanning direction X. Here, m is, for example, a predetermined number within a range of 500 to 10000. The reading unit 17 includes the plurality of image sensors 28. The plurality of image sensors 28 output luminance signals corresponding to incident light.

One light emitting unit 18 is disposed at one end portion or two light emitting units 18 are disposed at both end portions in the longitudinal direction of the support unit 27. In the example illustrated in FIG. 4, two light emitting units 18 are disposed at both the end portions in the longitudinal direction of the support unit 27. The support unit 27 includes a light guide member 29 capable of irradiating a reading target area with light while guiding, in the main scanning direction X, the light emitted from the light emitting unit 18 when the light emitting unit 18 is turned on. The light guide member 29 is, for example, a light guide. The light emitting unit 18 may be a white light source that emits white light or may include three types of light sources capable of respectively emitting monochromatic lights of red, green, and blue. The light emitting unit 18 may include, for example, a light emitting LED.

A pair of light guide members 29 is provided, in the sub scanning direction Y, at positions on both sides of the reading unit 17 including the line sensor 17L. The light guide member 29 guides the light from the light emitting unit 18 in the main scanning direction X to emit light from a light guide path of the guided light. The light emitted by the light guide member 29 illuminates a region to be read by the reading unit 17. The reading module 20 includes a lens (not illustrated) that condenses light on the line sensor 17L configuring the reading unit 17. The lens may include, for example, a lens array including one lens unit for each image sensor 28.

### Electric Configuration of the Image Reading Apparatus 11

Next, an electric configuration of the image reading apparatus 11 according to the present embodiment is explained with reference to FIG. 5. In FIG. 5, in the image reading apparatus 11, some of components of the image reading mechanism of the ADF scheme that are less related to the document placement detection device are omitted.

As illustrated in FIG. 5, the image reading apparatus 11 includes the control unit 50, the carriage motor 43, the reading unit 17, the light emitting unit 18, the opening and closing sensor 23, and the display unit 41.

The control unit 50 may include one or more processors that execute various kinds of processing according to a computer program. The control unit 50 may include one or more dedicated hardware circuits, for example, ASICs that execute at least some of kinds of processing. The control unit 50 may include a circuit including a combination of a processor and a hardware circuit. The processor includes a CPU and a memory 52 such as a RAM and a ROM. The memory 52 stores program codes or commands configured to cause the CPU to execute processing. A memory, that is, a computer readable medium includes all readable media that can be accessed by a general-purpose or dedicated computer.

The carriage motor 43, the reading unit 17, the light emitting unit 18, the opening and closing sensor 23, and the display unit 41 are electrically coupled to the control unit 50. The control unit 50 controls the carriage motor 43, the reading unit 17, and the light emitting unit 18 to thereby execute document placement detection processing of reading the document M1 and detecting that the document M1 has been placed on the placement surface 12A.

The control unit 50 includes an image reading control unit 51 and a memory 52. A control program PR and threshold data D1 are stored in the memory 52. The image reading control unit 51 includes software configured by a computer of the control unit 50 executing the control program PR and the like and hardware such as an ASIC. The image reading control unit 51 includes a carriage drive control unit 61, a reading control unit 62, a light emission control unit 63, a cover opening and closing determination unit 64, a display control unit 65, a first determination unit 66, and a second determination unit 67. The threshold data D1 includes various kinds of data such as thresholds for determination used by the first determination unit 66 and the second determination unit 67 for determination. The threshold data D1 includes, for example, a first threshold A1 used by the first determination unit 66 for determination and a second threshold A2 used by the second determination unit 67 for determination. The first threshold A1 and the second threshold A2 are set to values acquired by preliminary experiments or simulations such that the first determination unit 66 and the second determination unit 67 can perform appropriate determinations.

The carriage drive control unit 61 controls the carriage motor 43. The carriage drive control unit 61 moves the carriage 19 in the sub scanning direction Y by driving the carriage motor 43 to rotate forward and backward. The control unit 50 causes, with the movement of the carriage 19, the reading unit 17 and the light emitting unit 18 to perform scanning in the sub scanning direction Y.

The reading control unit 62 controls the reading unit 17. The reading control unit 62 controls a reading operation of the reading unit 17. The reading unit 17 outputs a read signal formed by an analog signal by reading the document M1. The control unit 50 generates read data by converting the read signal input from the reading unit 17 from the analog signal into a digital signal. The control unit 50 generates image data, which is a reading result of the document M1, by applying predetermined processing to the read data.

The light emission control unit 63 performs control for switching light emission and turn-off of the light emitting unit 18. The control unit 50 turns off the light emitting unit 18 in a standby state in which reading is not executed. The control unit 50 turns on the light emitting unit 18 during reading of the document M1. The control unit 50 turns off the light emitting unit 18 in the document placement detection processing of detecting that the document M1 has been placed on the placement surface 12A.

The cover opening and closing determination unit 64 receives input of a detection signal from the opening and closing sensor 23. The cover opening and closing determination unit 64 determines, based on the detection signal input from the opening and closing sensor 23, whether the document cover 15 is in the open state or the closed state. The opening and closing sensor 23 outputs a detection signal (an ON signal) when the document cover 15 is in the closed state and outputs a non-detection signal (an OFF signal) when the document cover 15 is in the open state. The opening and closing sensor 23 outputs the non-detection signal indicating the open state when an angle of the document cover 15 exceeds a predetermined angle larger than 0 degree. The opening and closing sensor 23 outputs the detection signal indicating the closed state when the angle of the document cover 15 is smaller than the predetermined angle.

The display control unit 65 controls the display unit 41. The display control unit 65 controls the display unit 41 to display information on the screen of the display unit 41 or switch information to be displayed on the screen. The display control unit 65 notifies the information to the user by displaying the information on the display unit 41. In a mode in which the user reads the thick document M1 such as the book B1 (a book scan mode), the display control unit 65 displays guidance information for the mode on the display unit 41. When the display unit 41 is a touch panel, the control unit 50 receives, from the operation unit 42 configuring the display unit 41, input of input information input by the user with touch operation.

The first determination unit 66 performs, based on a first reading result, which is a reading result of first reading processing explained below configuring the document placement detection processing, first determination of determining whether the document M1 placed on the placement surface 12A can be detected.

The second determination unit 67 performs, based on a difference between a second reading result, which is a reading result of second reading processing explained below configuring the document placement detection processing, and the first reading result, second determination of determining whether the document M1 has been placed on the placement surface 12A.

### Document Placement Detection Processing

Next, the document placement detection processing of detecting that the document M1 has been placed on the placement surface 12A is explained with reference to FIGS. 1 to 3 and FIGS. 6 to 9. The document placement detection processing includes first reading processing and second reading processing. The first reading processing is reading processing for acquiring a first reading result used in first determination of determining whether it is possible to detect that the document M1 has been placed on the placement surface 12A. The control unit 50 executes the second reading processing when the first determination unit 66 determines that the document M1 can be detected. The control unit 50 detects, based on the second reading result, which is the reading result of the second reading processing, and the first reading result, which is the reading result of the first reading processing, whether the document M1 has been placed on the placement surface 12A. This detection is performed by the second determination by the second determination unit 67. That is, the control unit 50 detects the presence or absence of the document M1 on the placement surface 12A by the second determination unit 67 performing the second determination of determining, based on the first reading result and the second reading result, whether the document M1 has been placed on the placement surface 12A.

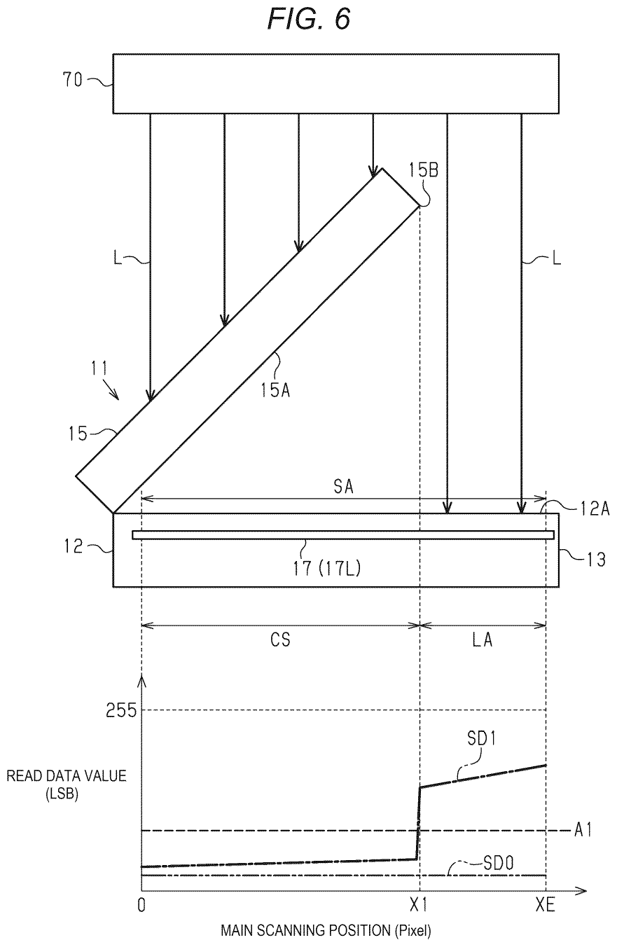

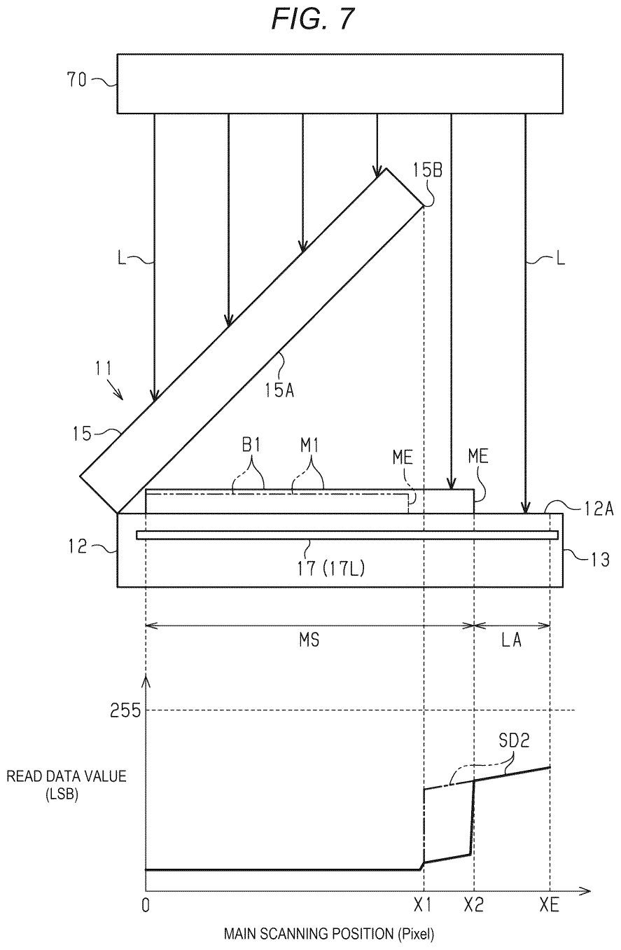

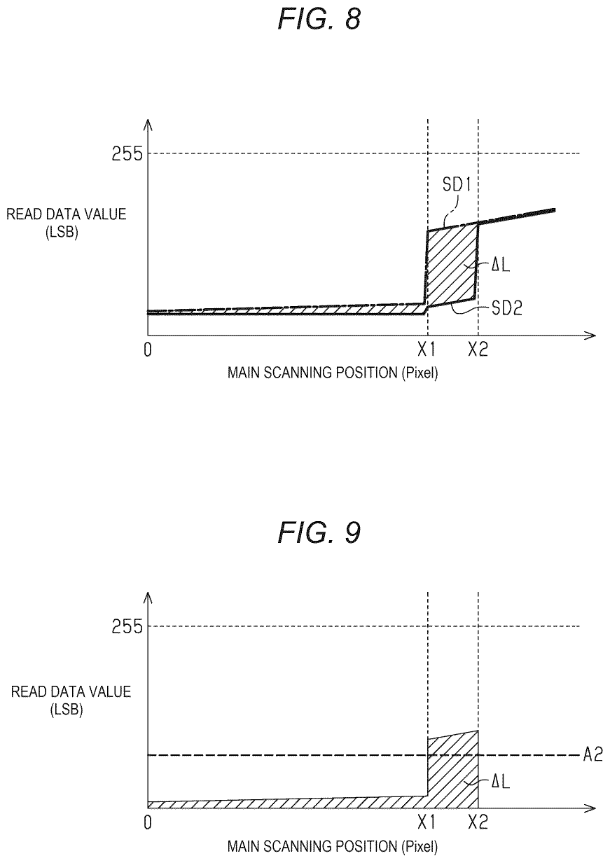

FIG. 6 is a diagram concerning the first reading processing. FIG. 7 is a diagram concerning the second reading processing. FIG. 8 is a graph illustrating the first reading result and the second reading result. FIG. 9 is a graph illustrating differential data between the first reading result and the second reading result. Hereinafter, the kinds of processing configuring the document placement detection processing is explained in order with reference to FIGS. 6 to 9.

### First Reading Processing

First, the first reading processing and the first determination are explained with reference to FIGS. 1 to 3 and 6. The control unit 50 executes the first reading processing of, when the document cover 15 is in the open state and before the document M1 is placed on the placement surface 12A, causing the reading unit 17 to carry out reading in a state in which the light emitting unit 18 is turned off. The control unit 50 executes the first reading processing based on a result of the opening and closing sensor 23 detecting the open state of the document cover 15. The control unit 50 executes the first reading processing in a state in which the control unit 50 causes the reading unit 17 to face the reading window section 21.

The control unit 50 executes first determination of determining, based on a first reading result, which is a reading result of the first reading processing, whether the document M1 placed on the placement surface 12A can be detected. Specifically, the first determination unit 66 of the control unit 50 performs the first determination.

The control unit 50 receives input of luminance signals corresponding to incident light from the plurality of image sensors 28 configuring the reading unit 17. The control unit 50 generates digital read data (see FIG. 6) based on the luminance signals input from the plurality of image sensors 28 configuring the reading unit 17.

The graph illustrated in FIG. 6 shows a first reading result SD1. The horizontal axis of this graph indicates a main scanning position and the vertical axis indicates a read data value. Here, the main scanning position is a pixel position indicating positions in the main scanning direction X of the plurality of (m) image sensors 28 configuring the reading unit 17. The read data value indicates a luminance value equivalent to a signal value at the time when luminance signals input from the plurality of image sensors 28 are converted into digital signals having predetermined tones (for example, 256 tones). The first reading result SD1 is equivalent to a luminance value represented by 256 tones. In the first determination, when there is a luminance signal exceeding the first threshold A1 among the luminance signals, which are the first reading result, the control unit 50 determines that the document M1 can be detected. That is, the first determination unit 66 of the control unit 50 determines whether there is data exceeding the first threshold A1 in the first reading result SD1 in a graph illustrated in a lower part of FIG. 6.

FIG. 6 illustrates a state in which the document cover 15 is in the open state and before the document M1 is placed. In a room where the image reading apparatus 11 is placed, the illumination unit 70 is attached at a predetermined height above the image reading apparatus 11. The illumination unit 70 illuminates the image reading apparatus 11 from a predetermined direction. In the example illustrated in FIG. 6, the illumination unit 70 is located substantially directly above the image reading apparatus 11. Outside light L from the illumination unit 70 is emitted to the image reading apparatus 11, for example, in an irradiation direction of the vertical direction Z.

A turning end 15B of the document cover 15 turns to draw an arcuate locus when the document cover 15 is opened and closed. For this reason, a shadow is formed in a region obtained by projecting the document cover 15 in the open state illustrated in FIG. 6 in the irradiation direction (for example, the vertical direction Z) and a bright region LA irradiated with the outside light L is formed further on the +X side in the main scanning direction X than a dark region CS formed of the shadow. A position X1 of a boundary between the dark region CS and the bright region LA is displaced in the main scanning direction X according to an opening angle of the document cover 15. A rising position X1 of the first reading result SD1 in the graph illustrated in FIG. 6 is equivalent to the boundary between the dark region CS and the bright region LA. When light intensity exceeding the first threshold A1 is present in the bright region LA, it is possible to detect, using the outside light L, that the document M1 has been placed on the placement surface 12A.

As illustrated in FIG. 6, when the document cover 15 is in the open state at a stage before the document M1 is placed on the placement surface 12A, the reading unit 17 detects the outside light L that is not blocked by the document cover 15. When the light intensity of the outside light L with which the placement surface 12A is irradiated is equal to or higher than certain intensity, as illustrated in FIG. 6, data exceeding the first threshold A1 is present in the read data of the first reading result SD1. In this case, the first determination unit 66 determines that the data exceeding the first threshold A1 is present in the first reading result SD1. On the other hand, when the document cover 15 is in the closed state (FIG. 1) or when the light intensity of the outside light L illustrated in FIG. 6 is low, a first reading result SD0 indicated by an alternate long and two short dashes line in the graph of FIG. 6 is obtained. Data exceeding the first threshold A1 is absent in the read data of the first reading result SD0. In this case, the first determination unit 66 determines that the presence or absence of the document M1 on the placement surface 12A cannot be detected.

### Second Reading Processing

Next, second reading processing is explained with reference to FIGS. 1 to 3 and 7.

When the result of the first determination indicates that detection is possible, the control unit 50 executes the second reading processing. That is, the control unit 50 executes the second reading processing of causing the reading unit 17 to carry out reading in a state in which the document cover 15 is in the open state and the light emitting unit 18 is turned off.

FIG. 7 illustrates a state in which the document cover 15 is in the open state and the document M1 is placed on the placement surface 12A. The position of the turning end 15B of the document cover 15 is the same as the position illustrated in FIG. 6. When the document M1 formed by the book B1 indicated by a solid line in FIG. 7 is placed on the placement surface 12A, a dark region MS due to a shadow of the book B1 is formed by the book B1 that blocks the outside light L. A position X2 of the boundary between the dark region MS and the bright region LA in a state in which the book B1 is placed is equivalent to the position of an end face ME on the +X side of the book B1. When the book B1 has the general size, the second position X2 is located further on the +X side than the first position X1 in many cases. That is, a part of the shadow of the book B1 placed on the placement surface 12A protrudes to the +X side from the position X1 of the boundary of the dark region CS, which is a region of the shadow of the document cover 15. The shadow of the portion of the book B1 protruding further to the +X side than the first position X1 of the book B1 changes to a dark region.

The graph illustrated in FIG. 7 shows a second reading result SD2. The horizontal axis of this graph indicates a main scanning position and the vertical axis indicates a read data value. The read data value is equivalent to a luminance value obtained by representing the luminance signals of the second reading result in 256 tones. In the graph illustrated in FIG. 7, a rising position X2 of the second reading result SD2 is equivalent to the position of the boundary between the dark region MS, which is the shadow of the book B1, and the bright region LA formed by irradiating a part of the placement surface 12A with the outside light L. That is, the rising position X2 is a position equivalent to the end face ME on the +X side of the book B1 placed on the placement surface 12A. Here, when the book B1 having the general size is placed on the placement surface 12A, the position of the end face ME of the book B1 is located further on the +X side than the first position X1. That is, the second reading result SD2 rises at the position X2 further on the +X side than the rising position X1 in the first reading result SD1 (see FIG. 6).

There is a case in which the book B1 having a size smaller than the general size indicated by an alternate long and two short dashes line in FIG. 7 is placed or a case in which an opening angle of the document cover 15 is considerably narrower than a normally opened angle. In these cases, the position of the end face ME on the +X side of the book B1 is the same as or a position further on the −X side than the position X1 of the boundary between the dark region and the bright region formed by the shadow of the document cover 15. In most cases except for such rare cases, the second position X2 is a position further on the +X side of the first position X1 (X1<X2).

### Second Determination

Next, the second determination is explained with reference to FIGS. 8 and 9. The control unit 50 executes the second determination of determining, based on the first reading result SD1 and the second reading result SD2, whether the document M1 has been placed on the placement surface 12A. That is, the control unit 50 detects, based on the difference between the first reading result obtained by the first reading processing and the second reading result obtained by the second reading processing, that the document M1 has been placed on the placement surface 12A. The control unit 50 executes the second determination of determining, based on the difference between the second reading result and the first reading result, whether the document M1 has been placed on the placement surface 12A. In the second determination, when there is differential data exceeding the second threshold A2 among differential data ΔL indicating the differences between the luminance signals in the first reading result and the luminance signals in the second reading result, the control unit 50 determines that the document M1 has been placed on the placement surface 12A. The second determination unit 67 of the control unit 50 performs the second determination.

FIG. 8 is a graph for comparing the first reading result SD1 and the second reading result SD2. The horizontal axis and the vertical axis of this graph are the same as the horizontal axis and the vertical axis in FIGS. 6 and 7. That is, the horizontal axis indicates the main scanning position and the vertical axis indicates the read data value indicating the luminance value. The second position X2, which is the rising position of the second reading result SD2, is located further on the +X side than the first position X1, which is the rising position of the first reading result SD1. A hatching region illustrated in FIG. 8 indicates a difference ΔL between the first reading result SD1 and the second reading result SD2. The difference ΔL increases in a region between the first position X1 and the second position X2 at the main scanning position. The reason for this is as follows. Before the book B1 is placed, the placement surface 12A is irradiated with the outside light L that is not blocked by the document cover 15 in the open state, whereby a bright region is formed in a region further on the +X side than the first position X1 in the placement surface 12A. When the book B1 is placed on the placement surface 12A, a part of the bright region before the placement of the book B1 changes to a dark region due to a shadow of a portion of the book B1 protruding from the first position X1 to the +X side. That is, the region between the first position X1 and the second position X2 changes from the bright region to the dark region. For this reason, the difference ΔL between the first reading result SD1 and the second reading result SD2 increases in the region between the first position X1 and the second position X2.

The second determination unit 67 calculates the differential data ΔL, which is the difference between the first reading result SD1 and the second reading result SD2. The second determination unit 67 calculates the differential data ΔL by subtracting the second reading result SD2 from the first reading result SD1 (ΔL=SD1−SD2). The differential data ΔL may be the absolute value of a subtraction value between the first reading result SD1 and the second reading result SD2 (ΔL=|SD1−SD2|).

The second determination unit 67 determines whether there is data exceeding the second threshold A2 among the differential data ΔL. When the book B1 is not placed on the placement surface 12A, the second reading result SD2 indicated by the alternate long and two short dashes line in the graph illustrated in FIG. 7 is obtained. The second reading result SD2 rises at the same first position X1 as that in the first reading result SD1 indicated by an alternate long and short dash line in the graph illustrated in FIG. 6. For this reason, a significant difference does not occur between the first reading result SD1 and the second reading result SD2. In this case, the second determination unit 67 determines that there is no data exceeding the second threshold A2 among the differential data ΔL.

On the other hand, when the book B1 is placed on the placement surface 12A, the second reading result SD2 indicated by a solid line in the graph illustrated in FIG. 7 is obtained. The second reading result SD2 rises at the second position X2 (>X1) different from the first position X1, which is the rising position of the first reading result SD1 indicated by the alternate long and short dash line in the graph illustrated in FIG. 6. For this reason, a significant difference occurs between the first reading result SD1 and the second reading result SD2. The second determination unit 67 determines that there is data exceeding the second threshold A2 among the differential data ΔL between the first reading result SD1 and the second reading result SD2. When a determination result that there is data satisfying ΔL>A2 is obtained, the second determination unit 67 detects that the document M1 has been placed on the placement surface 12A. When the positions X1 and X2, which are projection positions of the turning end 15B of the document cover 15 and the end face ME of the book B1 in an irradiation direction of the outside light L, do not satisfy X1<X2, there is no data exceeding the second threshold A2 among the differential data ΔL. In addition, as in the book B1 having the small size indicated by the alternate long and two short dashes line in FIG. 7, when the position of the end face ME of the book B1 is located further on the −X side in the main scanning direction X than the first position X1 of the turning end 15B of the document cover 15, there is no data exceeding the second threshold A2 in the differential data ΔL.

### Third Reading Processing

The control unit 50 executes third reading processing when the result of the first determination is negative and when the document M1 has not been successfully detected in the second determination. The third reading processing is processing of causing the reading unit 17 to carry out reading in a state in which the document cover 15 is in the open state and the light emitting unit 18 is turned on. The third reading processing may include reading (reading processing A) in a state in which the document cover 15 is in the open state and the light emitting unit 18 is turned off. The third reading processing may include reading (reading processing B) in a state in which the document cover 15 is in the open state and the light emitting unit 18 is turned on. The third reading processing may include reading (reading processing C) in a state in which the document cover 15 is in the closed state and the light emitting unit 18 is turned on.

The third reading processing may include the reading processing A and the reading processing B. In this case, based on the difference between a reading result of the reading processing A and a reading result of the reading processing B, since there is data in which differential data exceeds a threshold, the control unit 50 detects that the document M1 has been placed on the placement surface 12A.

Further, the third reading processing may include the reading processing A, the reading processing B, and the reading processing C. In this case as well, since there is data in which differential data between the reading result of the reading processing A and the reading result of the reading processing B exceeds the threshold, the control unit 50 detects that the document M1 has been placed on the placement surface 12A. When a black document M1 is placed on the placement surface 12A, since the differential data between the reading result of the reading processing A and the reading result of the reading processing B does not exceed the threshold, the presence or absence of the document M1 cannot be detected. However, the control unit 50 may detect the presence or absence of the black document M1 based on the differential data and a reading result of the reading processing C. That is, when the differential data is smaller than the threshold and the reading result of the reading processing C is smaller than the threshold, the control unit 50 determines that the document M1 has been placed on the placement surface 12A. On the other hand, when the differential data is smaller than the threshold and the reading result of the reading processing C is equal to or larger than the threshold, the control unit 50 determines that the document M1 has not been placed on the placement surface 12A. With this determination, the presence or absence of the black document M1 can also be detected based on a reading result of the third reading processing.

### Document Reading Processing

Next, document reading processing is explained. The control unit 50 executes the document reading processing of causing the reading unit 17 to read the document M1 based on detecting that the document M1 has been placed on the placement surface 12A. The control unit 50 executes the document reading processing when the result of the second determination indicates that the document M1 has been placed. The control unit 50 executes the document reading processing when the document cover 15 is in the open state. The control unit 50 controls the carriage motor 43 to move the carriage 19 to the document reading region SA in the sub scanning direction Y along the placement surface 12A. The control unit 50 causes the reading unit 17 to read the document M1 through the transparent plate 14 in a state in which the light emitting unit 18 is turned on during the movement of the carriage 19. The reading unit 17 reads the document M1 by receiving reflected light of light emitted by the light emitting unit 18 and reflected on the document M1. The control unit 50 generates image data based on read data read by the document reading processing. The control unit 50 may perform cutting processing of cutting out a reading part of a page of the book B1 from the image data. The control unit 50 may generate a file in a designated file format based on the image data. The file may include, for example, any one of a PDF file, a JPEG file, and a TIFF file.

### Action of the Embodiment

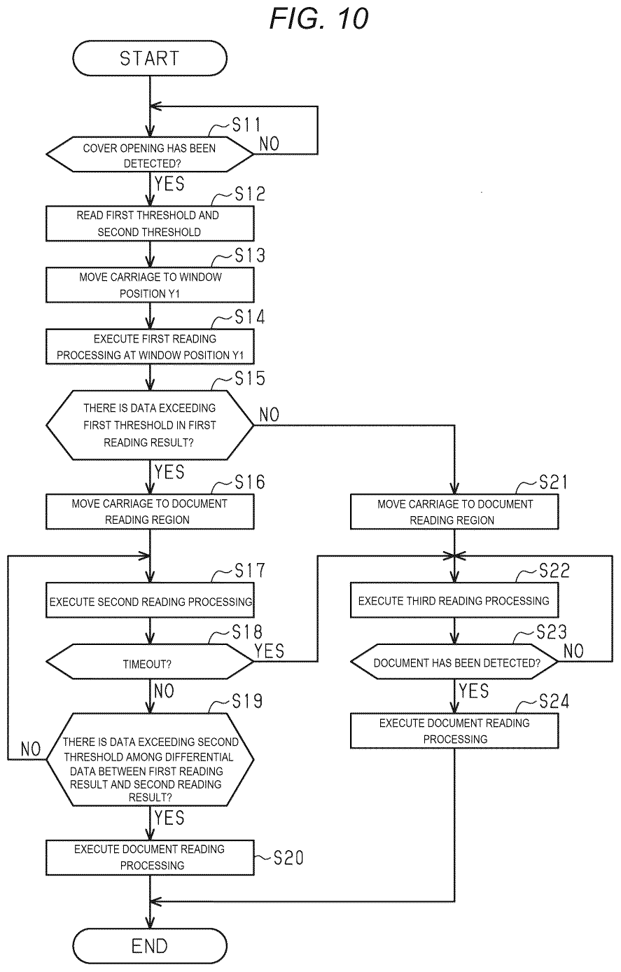

Next, action of the image reading apparatus 11 is explained with reference to FIG. 10 and the like. Hereinafter, a document reading control routine illustrated in FIG. 10 executed by the control unit 50 is explained. The document reading control routine includes the document placement detection processing. The user performs selection of reading (scanning) of the document M1, selection of reading conditions, selection of a document reading mode (for example, a book scan mode) including the document placement detection processing, and the like according to touch panel operation of the display unit 41. The user performs operation of instructing execution of reading to thereby instruct the image reading apparatus 11 to read the document M1. When an instructed mode is the document reading mode including the document placement detection processing, the control unit 50 having received the reading execution instruction of the user executes the document reading control routine illustrated in FIG. 10.

First, in step S11, the control unit 50 determines whether the open state of the document cover 15 has been detected. When the open state of the document cover 15 is detected, the processing proceeds to step S12. On the other hand, when the open state of the document cover 15 is not detected, that is, when the closed state of the document cover 15 is detected, the control unit 50 puts the processing on standby until the open state of the document cover 15 is detected.

In step S12, the control unit 50 reads the first threshold A1 and the second threshold A2.

In step S13, the control unit 50 moves the carriage 19 to the window position Y1. As illustrated in FIGS. 1 to 3, the carriage 19 moves to the window position Y1 facing the reading window section 21.

In the next step S14, the control unit 50 executes the first reading processing at the window position Y1. The control unit 50 executes the first reading processing of, when the document cover 15 is in the open state and before the document M1 is placed on the placement surface 12A, causing the reading unit 17 to carry out reading in a state in which the light emitting unit 18 is turned off. By executing the first reading processing at the window position Y1, for example, it is possible to avoid executing the first reading processing in a state in which the document M1 or the like is placed on the placement surface 12A. When the control unit 50 is configured to execute the first reading processing in the document reading region SA, it could occur that the control unit 50 executes the first reading processing in a state in which the document M1 or the like is placed on the placement surface 12A. In such a case, the control unit 50 cannot accurately perform the first determination. Therefore, in the present embodiment, a configuration in which the control unit 50 executes the first reading processing at the window position Y1 is adopted.

In step S15, the control unit 50 determines whether there is data exceeding the first threshold A1 in the first reading result. Processing relating to this determination is equivalent to the first determination performed by the first determination unit 66. As illustrated in FIG. 6, when the document cover 15 is opened at a stage before the document M1 is placed on the placement surface 12A, since the reading unit 17 detects the outside light L not blocked by the document cover 15, there is data exceeding the first threshold A1 in the read data. In this case, the control unit 50 determines that there is data exceeding the first threshold A1 in the first reading result. On the other hand, as illustrated in FIG. 1, when the document cover 15 is in the closed state or the light intensity of the outside light L illustrated in FIG. 6 is weak, there is no data exceeding the first threshold A1 in the read data. In this case, the control unit 50 determines that there is no data exceeding the first threshold A1 in the first reading result. The control unit 50 proceeds to step S16 when there is data exceeding the first threshold A1 and proceeds to step S21 when there is no data exceeding the first threshold A1.

In the next step S16, the control unit 50 moves the carriage 19 to the document reading region SA. As a result, the carriage 19 moves to the position indicated by the alternate long and two short dashes line in FIG. 1 in the document reading region SA.

The position at a movement destination of the carriage 19 at this time only has to be a position in the document reading region SA. For example, when the book B1 is opened and placed, a central portion equivalent to a back portion of the book B1 easily floats. For this reason, the outside light L is likely to enter below the book B1 around the central portion of the book B1. Therefore, a position equivalent to the back portion of the book B1 may be avoided. The movement destination position at the time when the carriage 19 moves to the document reading region SA may be, for example, a position within a predetermined range from the base end Y0 to a position equivalent to half of a width dimension of the book B1 in the sub scanning direction Y. Since the book B1 is sometimes not placed on a position in a vicinity region of the base end Y0, a position from a position slightly (for example, 10 mm) displaced from the base end Y0 to the +Y side in the sub scanning direction Y to a predetermined distance (for example, 100 mm) may be set as a movement destination position of the carriage 19.

In step S17, the control unit 50 executes the second reading processing. The control unit 50 executes the second reading processing of causing the reading unit 17 to carry out reading in a state in which the document cover 15 is in the open state and the light emitting unit 18 is turned off. The control unit 50 determines, based on a detection result of the opening and closing sensor 23, that the document cover 15 is in the open state. For example, when the user closes the document cover 15, when the control unit 50 detects, based on the detection result of the opening and closing sensor 23, that the document cover 15 is in the closed state, the control unit 50 interrupts the second reading processing and ends the routine.

In step S18, the control unit 50 determines whether a timeout has occurred. After the carriage 19 moves to the document reading region SA in step S16, the control unit 50 starts clocking of an elapsed time by a timer (not illustrated). When the elapsed time exceeds a set time (a timeout time) without the user placing the book B1, the control unit 50 determines that the timeout has occurred. The control unit 50 proceeds to step S19 when the timeout has not occurred and proceeds to step S22 when the timeout has occurred.

In step S19, the control unit 50 determines whether there is data exceeding the second threshold A2 among the differential data ΔL between the first reading result and the second reading result. The control unit 50 calculates a difference between the first reading result SD1 and the second reading result SD2 illustrated in FIG. 8. As a result of this calculation, the control unit 50 acquires the differential data ΔL illustrated in FIG. 9. Then, the control unit 50 determines whether there is data exceeding the second threshold A2 among the differential data ΔL illustrated in FIG. 9.

The position X1 where the first reading result SD1 rises in the graph illustrated in FIG. 6 is equivalent to a projection position of the turning end 15B of the document cover 15 in the irradiation direction of the outside light L. The second position X2 where the second reading result SD2 rises in the graph illustrated in FIG. 7 is equivalent to a projection position of the end face ME of the book B1, which is the document M1, in the irradiation direction of the outside light L. Normally, since the book B1 placed on the placement surface 12A comes into contact with the placement surface 12A, the second position X2 where the second reading result SD2 rises is equivalent to the position of the end face ME of the book B1. Here, as the positions X1 and X2 of the turning end 15B of the document cover 15 and the end face ME of the book B1, the second position X2 is larger than the first position X1 (X1<X2) in most cases when the book B1 has the general size. For this reason, when the book B1 is placed on the placement surface 12A, it is determined that there is data exceeding the second threshold A2 among the differential data ΔL. When there is data exceeding the second threshold A2 among the differential data ΔL, the control unit 50 detects that the document M1 is placed on the placement surface 12A. On the other hand, when the book B1 is not placed on the placement surface 12A, a significant difference from the first reading result SD1 indicated by the alternate long and short dash line in the graph illustrated in FIG. 6 does not occur as in the second reading result SD2 indicated by the alternate long and two short dashes line in the graph illustrated in FIG. 7. That is, the differential data ΔL is 0 (zero) or a value near zero. In this case, the control unit 50 determines that there is no data exceeding the second threshold A2 among the differential data ΔL.

When there is data exceeding the second threshold A2, the control unit 50 proceeds to processing in step S20. On the other hand, when there is no data exceeding the second threshold A2, the control unit 50 returns to the processing in step S17. In this case, the control unit 50 repeats the processing in steps S17 to S19 until determining that the document M1 is detected or determining that the timeout has occurred in step S18. In cases of some exceptions such as a case in which the opening angle of the document cover 15 is considerably narrower than usual or a case in which the book B1 having the small size indicated by the alternate long and two short dashes line in FIG. 7 is placed on the placement surface 12A, the control unit 50 determines that there is no data exceeding the second threshold A2 among the differential data ΔL. For this reason, in these cases, the timeout occurs in step S18.

In the next step S20, the control unit 50 executes the document reading processing. When detecting, with the determination result in step S19, that the document M1 has been placed on the placement surface 12A, the control unit 50 executes the document reading processing. In a state in which the light emitting unit 18 is turned on, the control unit 50 moves the carriage 19 in the sub scanning direction Y to cause the reading unit 17 to scan the document reading region SA. With this scanning, the reading unit 17 moves in the sub scanning direction Y while reading, through the transparent plate 14, a reading target area of the document M1 illuminated by the light emitting unit 18 that is on. The reading unit 17 performs a reading operation, for example, from the base end Y0 to a position passing the end face ME. As explained above, the control unit 50 executes the document reading processing of reading the document M1.

On the other hand, when the determination result is NO in step S15, in step S21, the control unit 50 moves the carriage 19 to the document reading region SA. That is, when determining in step S15 that there is no data exceeding the first threshold A1, the control unit 50 moves the carriage 19 from the window position Y1 to the document reading region SA in step S21.

In the next step S22, the control unit 50 executes the third reading processing. The third reading processing is reading processing in which the light emitting unit 18 is turned on and the reading unit 17 performs reading. The third reading processing only has to include reading processing in which the light emitting unit 18 is turned on and the reading unit 17 performs reading. The third reading processing may include at least one of the reading processing A, the reading processing B, and the reading processing C explained above. The third reading processing may include both of the reading processing A and the reading processing B. Further, the third reading processing may include the reading processing A, the reading processing B, and the reading processing C. When it is determined by the processing in steps S11 to S19 that document detection performed without involving the turn-on of the light emitting unit 18 is impossible or difficult, document detection processing involving the turn-on of the light emitting unit 18 is executed by the processing in steps S21 to S23. In the third reading processing executed by the control unit 50 in step S22, when the document M1 is placed on the placement surface 12A, the reading unit 17 receives reflected light of light with which the light emitting unit 18 illuminates the document M1. Therefore, a luminance value of read data increases in a range of the main scanning position equivalent to a region where the document M1 is present.

In the next step S23, the control unit 50 determines whether the document M1 has been detected. The control unit 50 determines, based on read data obtained as a third reading result, which is a reading result of the third reading processing, whether the document M1 has been placed on the placement surface 12A. For example, the control unit 50 may determine whether there is data exceeding a threshold in the read data. The control unit 50 may determine whether there is data exceeding the threshold in differential data of a plurality of reading results. Further, in the third reading processing including the reading processing A, the reading processing B, and the reading processing C, it may be determined, based on the respective reading results, for example, based on a condition of being able to detect a white or color document M1 and a condition of being able to detect a black document M1, whether the document M1 has been placed on the placement surface 12A. When a determination condition of being able to determine that the document M1 has been placed on the placement surface 12A is satisfied, the control unit 50 determines that the document M1 has been placed on the placement surface 12A. On the other hand, when the determination condition is not satisfied, the control unit 50 determines that the document M1 has not been placed on the placement surface 12A. In this way, the control unit 50 detects the presence or absence of the document M1. The control unit 50 proceeds to step S24 when the document M1 is detected and returns to the processing in step S22 when the document is not detected. In this case, the control unit 50 repeats the processing in step S22 and step S23 until it is determined in step S23 that the document M1 has been detected.

In step S24, the control unit 50 executes document reading processing. This document reading processing is the same as the document reading processing in step S20. The control unit 50 causes the reading unit 17 to read the document M1 in a state in which the light emitting unit 18 is turned on.

As explained above, in the processing in the present embodiment, it is detected, based on the reading result of the reading unit 17, that the user has placed the document M1 on the placement surface 12A. The light emitting unit 18 is not turned on at the time of the document detection. Thus, while reducing power consumption, it is possible to detect, using the reading result of the reading unit 17, that the document M1 has been placed on the placement surface 12A.

### Document Detection Method

The image reading apparatus 11 in the present embodiment includes the document table 12, the reading unit 17, the light emitting unit 18, and the document cover 15. A document detection method of detecting the document M1 placed on the document table 12 is implemented by the image reading apparatus 11. The document detection method includes the following (A) to (C).
(A) Before the document cover 15 is in the open state and the document M1 is placed on the placement surface 12A, executing the first reading processing of causing the reading unit 17 to carry out reading in the state in which the light emitting unit 18 is turned off.
(B) When it is determined, based on a result of executing the first reading processing, that the document M1 placed on the placement surface 12A can be detected, executing the second reading processing of causing the reading unit 17 to carry out reading in the state in which the document cover 15 is in the open state and the light emitting unit 18 is turned off.
(C) Detecting, based on the difference between a result of the second reading processing and the result of the first reading processing, the document M1 placed on the placement surface 12A.

The above (A) is equivalent to processing in steps S11, S13, and S14 in the example illustrated in FIG. 10.

The above (B) is equivalent to the processing in steps S15 to S17 in the example illustrated in FIG. 10.

The above (C) is equivalent to the processing in step S19 in the example illustrated in FIG. 10.

### Document Reading Method

In the present embodiment, a document reading method of reading the document M1 placed on the document table 12 in the image reading apparatus 11 includes the following (A) to (D).
(A) Before the document cover 15 is in the open state and the document M1 is placed on the placement surface 12A, executing the first reading processing of causing the reading unit 17 to carry out reading in the state in which the light emitting unit 18 is turned off.
(B) When it is determined, based on a result of executing the first reading processing, that the document M1 placed on the placement surface 12A can be detected, executing the second reading processing of causing the reading unit 17 to carry out reading in the state in which the document cover 15 is in the open state and the light emitting unit 18 is turned off.
(C) Detecting, based on the difference between a result of the second reading processing and the result of the first reading processing, that the document M1 has been placed on the placement surface 12A.
(D) Executing, based on a result of detecting that the document M1 has been placed on the placement surface 12A, the document reading processing of causing the reading unit 17 to read the document M.

That is, the document reading method includes the document detection method explained above (the above (A) to (C)) and the above (D). The above (A) to (C) are respectively equivalent to the kinds of processing indicated by the step numbers in FIG. 10 in the document detection method explained above. Further, the above (D) is equivalent to the processing in step S20 in the example illustrated in FIG. 10.

### Effects of the Embodiment

According to the embodiment, effects explained below can be obtained.
(1) The image reading apparatus 11 includes the document table 12, the reading unit 17, the light emitting unit 18, the document cover 15, and the control unit 50. The document table 12 has a placement surface 12A on which a document M1 is placed. The reading unit 17 reads, on the side opposite to the placement surface 12A, the document M1 placed on the placement surface 12A of the document table 12. The light emitting unit 18 is capable of switching turn-on and turn-off and illuminates the document M1 from the side opposite to the placement surface 12A of the document table 12 in the turn-on state. The document cover 15 opens and closes the placement surface 12A of the document table 12. The control unit 50 executes the first reading processing of, when the document cover 15 is in the open state and before the document M1 is placed on the placement surface 12A, causing the reading unit 17 to carry out reading in a state in which the light emitting unit 18 is turned off. The control unit 50 executes the second reading processing of causing the reading unit 17 to carry out reading in a state in which the document cover 15 is in the open state and the light emitting unit 18 is turned off. The control unit 50 detects that the document M1 has been placed on the placement surface 12A based on the difference between the first reading result obtained by the first reading processing and the second reading result obtained by the second reading processing. The control unit 50 executes the document reading processing of causing the reading unit 17 to read the document M1 based on detecting that the document M1 has been placed on the placement surface 12A. With this configuration, even when the document cover 15 remains in the open state, since it is possible to detect that the document M1 has been placed on the placement surface 12A of the document table 12 in the state in which the light emitting unit 18 is turned off, it is possible to implement document detection with low power consumption. Since a driving frequency, a driving time, and the like of the light emitting unit 18 can be reduced, deterioration of the light emitting unit 18 can be reduced and the life of the light emitting unit 18 can be increased.
(2) The control unit 50 executes, based on the first reading result, the first determination of determining whether the document M1 placed on the placement surface 12A can be detected. When the result of the first determination indicates that detection is possible, the control unit 50 executes the second reading processing. The control unit 50 executes the second determination of determining, based on the difference between the second reading result and the first reading result, whether the document M1 has been placed on the placement surface 12A. The control unit 50 executes the document reading processing when the result of the second determination indicates that the document M1 has been placed. With this configuration, since the second reading processing is executed only when it is confirmed that the document M1 can be detected, it is possible to suppress a delay in the start of the document reading processing due to execution of useless processing.
(3) The control unit 50 executes the document reading processing when the document cover 15 is in the open state. With this configuration, the user can cause the reading unit 17 to read the document M1 even when the user does not close the document cover 15 after placing the document M1 on the placement surface 12A.
(4) When the result of the first determination is negative, the control unit 50 executes the third reading processing of causing the reading unit 17 to carry out reading in the state in which the document cover 15 is in the open state and the light emitting unit 18 is turned on. With this configuration, when determining, based on the first reading result, that the document M1 placed on the placement surface 12A cannot be detected, the control unit 50 causes the reading unit 17 to carry out reading in the state in which the document cover 15 is in the open state and the light emitting unit 18 is turned on. Therefore, it is possible to easily detect the document M1.
(5) The reading unit 17 includes a plurality of image sensors that output luminance signals corresponding to incident light. In the first determination, when there is a luminance signal exceeding the first threshold among the luminance signals in the first reading result, the control unit 50 determines that the document M1 can be detected. In the second determination, when there is differential data exceeding the second threshold among the differential data indicating the difference between the luminance signal in the first reading result and the luminance signal in the second reading result, the control unit 50 determines that the document M1 has been placed on the placement surface 12A. With this configuration, it is possible to determine, with accuracy corresponding to the resolution of the plurality of image sensors, whether the document M1 has been placed. Thus, since it is possible to reduce a determination error (a document detection error) of determining that the document M1 has not been placed regardless of the fact that the document M1 has been placed, it is possible to further contribute to a reduction in power consumption.
(6) The image reading apparatus 11 includes the carriage 19. The carriage 19 moves the reading unit 17 along the document table 12. In the document table 12, a reading window section that the reading unit 17 can face is provided on the outer side of the placement surface 12A in a plan view. The control unit 50 executes the first reading processing in a state in which the carriage 19 is moved to cause the reading unit 17 to face the reading window section. With this configuration, even when the document M1 has been placed at the time of the first reading processing, the first reading processing can be carried out at a place where the document M1 is not placed.
(7) The image reading apparatus 11 further includes an opening and closing sensor that detects opening and closing of the document cover 15. The control unit 50 executes the first reading processing based on a result of the opening and closing sensor detecting the open state of the document cover 15. With this configuration, the first reading processing can be carried out after the user switches the document cover 15 to the open state in order to place the document M1 on the placement surface 12A. Thus, power consumption can be reduced compared with a configuration in which the first reading processing is carried out before the user switches the document cover 15 to the open state.
(8) A document detection method of detecting the document M1 placed on the document table 12 in the image reading apparatus 11 including the document table 12, the reading unit 17, the light emitting unit 18, and the document cover 15 includes the following (A) to (C).
(A) Before the document cover 15 is in the open state and the document M1 is placed on the placement surface 12A, executing the first reading processing of causing the reading unit 17 to carry out reading in the state in which the light emitting unit 18 is turned off.
(B) When it is determined, based on a result of executing the first reading processing, that the document M1 placed on the placement surface 12A can be detected, executing the second reading processing of causing the reading unit 17 to carry out reading in the state in which the document cover 15 is in the open state and the light emitting unit 18 is turned off.
(C) Detecting, based on the difference between a result of the second reading processing and the result of the first reading processing, the document M1 placed on the placement surface 12A.

With this method, even when the document cover 15 remains in the open state, since it is possible to detect that the document M1 has been placed on the placement surface 12A of the document table 12 in a state in which the light emitting unit 18 is turned off, it is possible to implement document detection with low power consumption.
(9) A document reading method of reading the document M1 placed on the document table 12 in the image reading apparatus 11 including the document table 12, the reading unit 17, the light emitting unit 18, and the document cover 15 includes the following (A) to (C).
(A) Before the document cover 15 is in the open state and the document M1 is placed on the placement surface 12A, executing the first reading processing of causing the reading unit 17 to carry out reading in the state in which the light emitting unit 18 is turned off.
(B) When it is determined, based on a result of executing the first reading processing, that the document M1 placed on the placement surface 12A can be detected, executing the second reading processing of causing the reading unit 17 to carry out reading in the state in which the document cover 15 is in the open state and the light emitting unit 18 is turned off.
(C) Detecting, based on the difference between a result of the second reading processing and the result of the first reading processing, that the document M1 has been placed on the placement surface 12A.
(D) Executing, based on a result of detecting that the document M1 has been placed on the placement surface 12A, the document reading processing of causing the reading unit 17 to read the document M.

With this document reading method, even when the document cover 15 remains in the open state, it is possible to detect that the document M1 has been placed on the placement surface 12A of the document table 12 in the state in which the light emitting unit 18 is turned off. Thus, since the document detection can be implemented with low power consumption even when the document cover 15 remains in the open state, the document M1 can be read with low power consumption.

### Modifications

The above embodiment can be modified into forms like modifications explained below. Further, an appropriate combination of the embodiment explained above and the modifications explained below can be obtained as another modifications and an appropriate combination of the modifications explained below can be obtained as another modification.

Opening and closing of the document cover 15 may be detected by the document placement detection processing. When there is data exceeding the first threshold A1 in the read data of the reading unit 17, the control unit 50 determines that the document cover 15 is in the open state. When all pieces of data in the read data of the reading unit 17 are equal to or smaller than the first threshold A1, the control unit 50 determines that the document cover 15 is in the closed state. With this configuration, the opening and closing of the document cover 15 can be detected by the reading unit 17. Further, when it is determined that the document cover 15 is in the open state, an opening degree (an opening angle) of the document cover 15 may be detected based on a boundary position BX in the main scanning direction X between data (dark data) equal to or smaller than the first threshold A1 and data (bright data) exceeding the first threshold A1 in the read data. When the opening and closing of the document cover 15 is detected, when the boundary position BX based on the read data exceeds the threshold BX1 on the main scanning position, it may be determined that the document cover 15 is in the closed state and, on the other hand, when the boundary position BX is equal to or smaller than the threshold BX1, it may be determined that the document cover 15 is in the open state. In this case, by changing the setting of the threshold BX1, a switching angle of the detected opening and closing of the document cover 15 may be adjusted. As explained above, the document placement detection processing may be used for cover opening and closing detection processing of detecting opening and closing of the document cover 15. In this case, with the use of the cover opening and closing detection processing, for example, by replacing the opening and closing sensor 23 with the cover opening and closing detection processing, the opening and closing sensor 23 may be eliminated. The opening and closing sensor 23 and the cover opening and closing detection processing may be concurrently used. In this case, the setting of the opening and closing switching angle of the document cover 15 may be the same or may be different in the opening and closing sensor 23 and the cover opening and closing detection processing. A detection result of the opening and closing sensor 23 may be used to correct a detection result in the cover opening and closing detection processing.

The determination processing in step S11 in FIG. 10 may be performed by the cover opening and closing detection processing in the modification explained above. For example, when receiving a reading execution instruction given by the user operating the operation unit 42, the control unit 50 may start execution of the document reading control routine illustrated in FIG. 10 and perform the cover opening detection determination processing in step S11 with the cover opening and closing detection processing.

The control unit 50 may detect a size of the document M1 using the document placement detection processing. When detecting placement of the document M1 with the document placement detection processing, the control unit 50 may detect the length in the main scanning direction X of the placed document M1 based on read data. The control unit 50 may detect, as the length (the depth dimension) in the main scanning direction X of the document M1, a coordinate value of the position X2 (see FIG. 7) of the boundary between the range of the main scanning position taken by the data (the black data) equal to or smaller than the second threshold A2 in the read data of the reading unit 17 and the range of the main scanning position taken by the data (the white data) exceeding the second threshold A2. This is based on the premise that the document M1 is placed such that the end edge on the back side (the −X side) of the document M1 extends along a first reference side (X=0) on the back side (the −X side) of the placement surface 12A. Further, the control unit 50 may detect the length (the width dimension) in the sub scanning direction Y of the document M1. After the document detection, the control unit 50 causes the reading unit 17 to perform scanning in the sub scanning direction Y under the open state of the document cover 15 and the turn-off state of the light emitting unit 18. The control unit 50 detects the position of the end portion YM (see FIG. 2) in the sub scanning direction Y of the document M1 based on the read data. The control unit 50 sets a coordinate value in the sub scanning direction Y of the detected end portion YM as the length in the sub scanning direction Y of the document M1. As explained above, even when the document cover 15 remains in the open state, the length of the document M1 can be detected using the outside light L while the light emitting unit 18 remains in the turn-off state. In this case, the control unit 50 may detect only the length in the main scanning direction X of the document M1, detect only the length in the sub scanning direction Y of the document M1, or detect the lengths in both of the main scanning direction X and the sub scanning direction Y of the document M1. This is based on the premise that the document M1 is placed such that the end edge on the −Y side in the sub scanning direction Y of the document M1 extends along a second reference side (Y0=0) on the −Y side of the placement surface 12A. In contrast, when the reading unit 17 performs scanning in the sub scanning direction Y, the control unit 50 may detect the position of the end edge on the −Y side in the sub scanning direction Y of the document M1 in the same manner. For example, after the document detection, the control unit 50 detects the positions of end edges YE1 and YE2 on both sides in the sub scanning direction Y of the document M1 by causing the reading unit 17 to perform scanning in the sub scanning direction Y. The control unit 50 may calculate YE2−YE1 and set YE2−YE1 as the length in the sub scanning direction Y of the document M1.

In the embodiment, the control unit 50 executes the first reading processing in the state in which the reading unit 17 is present at the window position Y1. However, the control unit 50 may execute the first reading processing in a state in which the reading unit 17 is present at a position in the document reading region SA. That is, the first reading position Y1 may be a position in the document reading region SA instead of the window position. In this case, the first reading position Y1, which is the position of the reading unit 17 at the time when the first reading processing is executed, and the second reading position Y2, which is the position of the reading unit 17 at the time when the second reading processing is executed, may be the same position or may be different positions.

In the embodiment, the first threshold A1 and the second threshold A2 may be the same value or may be different values.

An opening and closing motion of the document cover 15 configured to be capable of turning with respect to the document table 12 is not limited to a configuration by only a turning motion. The document cover 15 only has to involve a turning motion with respect to the document table 12 in at least a part of an opening and closing motion involving displacement in the main scanning direction X. For example, the opening and closing motion of the document cover 15 may include an ascending motion of the document cover 15 ascending while keeping a predetermined posture or a horizontal motion of the document cover 15 horizontally sliding in the X direction.

The control unit 50 may execute the document reading processing when the document cover 15 is in the closed state.

The control unit 50 may be configured not to perform the first determination. For example, the determination processing in step S15 in FIG. 10 may be eliminated.

When the opening and closing sensor 23 is detecting the open state of the document cover 15, a photoelectric conversion time at the time of image reading of the line sensor 17L configuring the reading unit 17 may be the same time as a photoelectric conversion time at the time of normal image reading or may be increased as in the technique described in JP-A-2013-85047.

Before the operation of reading the document M1, the control unit 50 may perform a preliminary reading operation (pre-scan) in order to detect the size of the document M1. In this case, when performing the document placement detection processing in the embodiment and the modifications explained above and detecting that the document M1 has been placed, the control unit 50 may perform the preliminary reading operation (the pre-scan). The preliminary reading operation may be a preliminary reading operation for image check for the user to check a document image in advance instead of the size detection. The control unit 50 may display, as a preview, the document image read in the preliminary reading operation on a display unit of an external device such as a PC.

After detecting the placement of the document with the document placement detection processing in the embodiment and the modifications explained above, the control unit 50 may detect a document size with the method described in JP-A-2013-85047.

The reading unit 17 is not limited to the CIS scheme and may adopt a charge coupled device (CCD) scheme (a reduction optical scheme).

The document M1 is not limited to the book B1 or the booklet and may be printed paper. In this case, the paper may have a size larger or may have a size smaller than the placement surface 12A. The document M1 may be placed with a part thereof protruding from the placement surface 12A or may be placed without protruding. The document M1 may be a three-dimensional object other than the book B1. Besides, the document M1 may be various documents that are desirably read in the open state in which the document cover 15 is opened.

The functional units in the control unit 50 are not limited to being implemented by the CPU and may be implemented by hardware with an electronic circuit such as an ASIC (application specific integrated circuit) or an FPGA (field-programmable gate array) or may be implemented by both of software and hardware. For example, some or all of the units 61 to 67 configuring the control unit 50 illustrated in FIG. 5 may include hardware instead of software. For example, the control unit 50 may include an ASIC and at least some or all of the units 61 to 67 may include ASICs or FPGAs.

The image reading apparatus 11 may not include the auto document feeder 24. That is, the image reading apparatus 11 may be a flatbed image reading apparatus not including an ADF image reading function.

The image reading apparatus 11 may be mounted on an upper portion of a printing apparatus as a part of a multifunction peripheral. That is, the image reading apparatus 11 may be a part of the multifunction peripheral mounted on the upper portion of the printing apparatus. The multifunction peripheral of this type may be a consumer multifunction peripheral for individuals or homes or may be a business or office multifunction peripheral.

The expression “at least one” used in the present specification means “one or more” of desired choices. For example, the expression “at least one” used in the present specification means “only one of choice” or “both of two choices” when the number of choices is two. As another example, the expression “at least one” used in the present specification means “just one choice” or “a combination of two or more any choices” when the number of the choices is three or more.

### Technical Ideas

As below, technical ideas grasped from the embodiment and the modifications explained above are described together with effects.
[1] An image reading apparatus includes: a document table having a placement surface on which a document is placed; a reading unit configured to read, on a side opposite to the placement surface, the document placed on the placement surface of the document table; a light emitting unit capable of switching turn-on and turn-off and configured to illuminate the document from the side opposite to the placement surface of the document table in a turn-on state; a document cover configured to open and close the placement surface of the document table; and a control unit. Based on detecting placement of the document on the placement surface based on a difference between a first reading result obtained by first reading processing of, when the document cover is in an open state and before the document is placed on the placement surface, causing the reading unit to carry out reading in a state in which the light emitting unit is turned off and a second reading result obtained by second reading processing of causing the reading unit to carry out reading in a state in which the document cover is in the open state and the light emitting unit is turned off, the control unit executes document reading processing of causing the reading unit to read the document. With this configuration, even when the document cover remains in the open state, it is possible to detect that the document has been placed on the placement surface of the document table in the state in which the light emitting unit is turned off. Therefore, it is possible to implement document detection with low power consumption.
[2] In the image reading apparatus described in above [1], the control unit may execute, based on the first reading result, first determination of determining whether the document placed on the placement surface can be detected, execute the second reading processing when a result of the first determination indicates that the document can be detected, execute, based on a difference between the second reading result and the first reading result, second determination of determining whether the document was placed on the placement surface, and execute the document reading processing when a result of the second determination indicates that the document was placed. With this configuration, since the second reading processing is executed only when it has been successfully confirmed that the document can be detected, it is possible to suppress a delay in the start of the document reading processing due to execution of useless processing.
[3] In the image reading apparatus described in above [2], the control unit may execute the document reading processing when the document cover is in the open state. With this configuration, the user can cause the image reading apparatus to read the document even when the user does not close the document cover after placing the document on the placement surface.
[4] In the image reading apparatus described in above [2] or [3], when the result of the first determination is negative, the control unit may execute third reading processing of causing the reading unit to carry out reading in a state in which the document cover is in the open state and the light emitting unit is turned on. With this configuration, when it is determined, based on the first reading result, that the document placed on the placement surface cannot be detected, the control unit causes the reading unit to carry out reading in the state in which the document cover is in the open state and the light emitting unit is turned on. Therefore, it is possible to make it easy to detect the document.
[5] In the image reading apparatus described in any one of above [2] to [4], the reading unit may include a plurality of image sensors that output luminance signals corresponding to incident light, and, in the first determination, when there is a luminance signal exceeding a first threshold among the luminance signals in the first reading result, the control unit may determine that the document can be detected and, in the second determination, when there is differential data exceeding a second threshold among differential data indicating differences between the luminance signals in the first reading result and the luminance signals in the second reading result, the control unit may determine that the document was placed on the placement surface. With this configuration, it is possible to determine, with accuracy corresponding to the resolution of the plurality of image sensors, whether the document has been placed. Thus, it is possible to reduce a determination error (a document detection error) in which it is determined that the document has not been placed regardless of the fact that the document has been placed. Therefore, it is possible to further contribute to a reduction in power consumption.
[6] In the image reading apparatus described in any one of above [1] to [5], the image reading apparatus may further include a carriage configured to move the reading unit along the document table, a reading window section that the reading unit can face is provided on an outer side of the placement surface in plan view, and the control unit may execute the first reading processing in a state in which the carriage is moved to cause the reading unit to face the reading window section. With this configuration, even when a document has been placed at the time of the first reading processing, the first reading processing can be carried out at a place where the document is not placed.
[7] In the image reading apparatus described in any one of above [1] to [6], the image reading apparatus may further include an opening and closing sensor configured to detect opening and closing of the document cover, and the control unit may execute the first reading processing based on a result of the opening and closing sensor detecting the open state of the document cover. With this configuration, the first reading processing can be carried out after the user switches the document cover to the open state. Thus, it is possible to reduce power consumption compared with a configuration in which the first reading processing is carried out before the user switches the document cover to the open state.
[8] A document detection method is a document detection method of detecting a document placed on a document table in an image reading apparatus including: the document table having a placement surface on which the document is placed; a reading unit configured to read, on a side opposite to the placement surface, the document placed on the placement surface of the document table; a light emitting unit capable of switching turn-on and turn-off and configured to illuminate the document from the side opposite to the placement surface of the document table in a turn-on state; and a document cover configured to open and close the placement surface of the document table, the document detection method including: when it is determined, based on a result of executing first reading processing of, when the document cover is in an open state and before the document is placed on the placement surface, causing the reading unit to carry out reading in a state in which the light emitting unit is turned off, that the document placed on the placement surface can be detected, executing second reading processing of causing the reading unit to carry out reading in a state in which the document cover is in the open state and the light emitting unit is turned off; and detecting the document placed on the placement surface based on a difference between a result by the second reading processing and a result by the first reading processing. With the document detection method, even when the document cover remains in the open state, it is possible to detect that the document has been placed on the placement surface of the document table in a state in which the light emitting unit is turned off. Therefore, it is possible to implement document detection with low power consumption.
[9] A document reading method is a document reading method of reading a document placed on a document table in an image reading apparatus including: the document table having a placement surface on which the document is placed; a reading unit configured to read, on a side opposite to the placement surface, the document placed on the placement surface of the document table; a light emitting unit capable of switching turn-on and turn-off and configured to illuminate the document from the side opposite to the placement surface of the document table in a turn-on state; and a document cover configured to open and close the placement surface of the document table, the document detection method including: when it is determined, based on a result of executing first reading processing of, when the document cover is in an open state and before the document is placed on the placement surface, causing the reading unit to carry out reading in a state in which the light emitting unit is turned off, that the document placed on the placement surface can be detected, executing second reading processing of causing the reading unit to carry out reading in a state in which the document cover is in the open state and the light emitting unit is turned off; detecting, based on a difference between a result by the second reading processing and a result by the first reading processing, that the document was placed on the placement surface; and executing, based on a result of detecting that the document was placed on the placement surface, document reading processing of causing the reading unit to read the document. With the document reading method, even when the document cover remains in the open state, it is possible to detect that the document has been placed on the placement surface of the document table in a state in which the light emitting unit is turned off. Thus, since the document detection can be implemented with low power consumption even when the document cover remains in the open state, the document can be read with low power consumption.

What is claimed is:

1. An image reading apparatus comprising:
a document table having a placement surface on which a document is placed;
a reading unit configured to read, on a side opposite to the placement surface, the document placed on the placement surface of the document table;
a light emitting unit capable of switching turn-on and turn-off and configured to illuminate the document from the side opposite to the placement surface of the document table in a turn-on state;
a document cover configured to open and close the placement surface of the document table; and
a control unit, wherein
based on detecting placement of the document on the placement surface based on a difference between a first reading result obtained by first reading processing of, when the document cover is in an open state and before the document is placed on the placement surface, causing the reading unit to carry out reading in a state in which the light emitting unit is turned off and a second reading result obtained by second reading processing of causing the reading unit to carry out reading in a state in which the document cover is in the open state and the light emitting unit is turned off, the control unit executes document reading processing of causing the reading unit to read the document.

2. The image reading apparatus according to claim 1, wherein the control unit executes, based on the first reading result, first determination of determining whether the document placed on the placement surface can be detected, executes the second reading processing when a result of the first determination indicates that the document can be detected, executes, based on a difference between the second reading result and the first reading result, second determination of determining whether the document was placed on the placement surface, and executes the document reading processing when a result of the second determination indicates that the document was placed.

3. The image reading apparatus according to claim 2, wherein the control unit executes the document reading processing when the document cover is in the open state.

4. The image reading apparatus according to claim 2, wherein, when the result of the first determination is negative, the control unit executes third reading processing of causing the reading unit to carry out reading in a state in which the document cover is in the open state and the light emitting unit is turned on.

5. The image reading apparatus according to claim 2, wherein
the reading unit may include a plurality of image sensors that output luminance signals corresponding to incident light, and
in the first determination, when there is a luminance signal exceeding a first threshold among the luminance signals in the first reading result, the control unit determines that the document can be detected and, in the second determination, when there is differential data exceeding a second threshold among differential data indicating differences between the luminance signals in the first reading result and the luminance signals in the second reading result, the control unit determines that the document was placed on the placement surface.

6. The image reading apparatus according to claim 2, further comprising a carriage configured to move the reading unit along the document table, wherein
a reading window section that the reading unit can face is provided on an outer side of the placement surface in plan view, and
the control unit executes the first reading processing in a state in which the carriage is moved to cause the reading unit to face the reading window section.

7. The image reading apparatus according to claim 2, further comprising an opening and closing sensor configured to detect opening and closing of the document cover, wherein
the control unit executes the first reading processing based on a result of the opening and closing sensor detecting the open state of the document cover.

8. A document detection method of detecting a document placed on a document table in an image reading apparatus including:
the document table having a placement surface on which the document is placed;
a reading unit configured to read, on a side opposite to the placement surface, the document placed on the placement surface of the document table;
a light emitting unit capable of switching turn-on and turn-off and configured to illuminate the document from the side opposite to the placement surface of the document table in a turn-on state; and
a document cover configured to open and close the placement surface of the document table
the document detection method comprising:
when it is determined, based on a result of executing first reading processing of, when the document cover is in an open state and before the document is placed on the placement surface, causing the reading unit to carry out reading in a state in which the light emitting unit is turned off, that the document placed on the placement surface can be detected, executing second reading processing of causing the reading unit to carry out reading in a state in which the document cover is in the open state and the light emitting unit is turned off; and
detecting the document placed on the placement surface based on a difference between a result by the second reading processing and a result by the first reading processing.

9. A document reading method of reading a document placed on a document table in an image reading apparatus including:
the document table having a placement surface on which the document is placed;
a reading unit configured to read, on a side opposite to the placement surface, the document placed on the placement surface of the document table;
a light emitting unit capable of switching turn-on and turn-off and configured to illuminate the document from the side opposite to the placement surface of the document table in a turn-on state; and
a document cover configured to open and close the placement surface of the document table,
the document detection method comprising:
when it is determined, based on a result of executing first reading processing of, when the document cover is in an open state and before the document is placed on the placement surface, causing the reading unit to carry out reading in a state in which the light emitting unit is turned off, that the document placed on the placement surface can be detected, executing second reading processing of causing the reading unit to carry out reading in a state in which the document cover is in the open state and the light emitting unit is turned off;
detecting, based on a difference between a result by the second reading processing and a result by the first reading processing, that the document was placed on the placement surface; and
executing, based on a result of detecting that the document was placed on the placement surface, document reading processing of causing the reading unit to read the document.
